(19) United States
(12) Patent Application Publication
(10) Pub. No.: US 2026/0187560 A1
(43) Pub. Date: Jul. 2, 2026

(54) AUTOMATED SERVICE FOR INVOKING AN AUTOMATED ASSISTANT SERVICE WITHIN A COLLABORATION PLATFORM

(71) Applicant: Atlassian Pty Ltd., Sydney (AU)

(72) Inventors: Tyler Brown, Bloomington, IN (US); Alexander Williams, Richmond, VA (US); Avinoam Zelenko, Parkland, FL (US); Dhanraj Jadhav, Union City, CA (US)

(21) Appl. No.: 19/265,485

(22) Filed: Jul. 10, 2025

Related U.S. Application Data
(63) Continuation of application No. 19/006,187, filed on Dec. 30, 2024.

(51) Int. Cl. G06Q 10/0631; G06F 40/30; G06Q 10/10

(52) U.S. Cl. CPC G06Q 10/06316; G06F 40/30; G06Q 10/103

(57) ABSTRACT

Embodiments described herein relate to systems and methods for deploying automated assistant services or conversational bots using an automation service. The automations service includes a series of automation components that are executed in accordance with a workflow in response to a trigger condition being satisfied. The automation service includes one or more automated assistant service components, which may invoke use of generative output engine having a large-language model in order to produce generative content. The generative content may be used by subsequent automation components to produce the automation service result. Content creation and modification may be performed using the permissions of a respective system user and attributed to the automated assistant service.

### CROSS-REFERENCE TO RELATED APPLICATION(S)

This application is a continuation patent application of U.S. patent application Ser. No. 19/006,187, filed Dec. 30, 2024 and titled “Automation Service for Invoking an Automated Assistant Service in a Collaboration Platform,” the disclosure of which is hereby incorporated herein by reference in its entirety.

### TECHNICAL FIELD

Embodiments described herein relate to multi-tenant services of collaborative work environments and, in particular, to systems and methods for generating and executing automation rules that can be used to invoke automated service assistant actions in a collaboration platform.

### BACKGROUND

An organization can establish a collaborative work environment by self-hosting, or providing its employees with access to, a suite of discrete software platforms or services to facilitate cooperation and completion of work. However, in some instances, the discrete software platforms are operated through discrete user interfaces and accomplishing cross-platform tasks may require manual operation or involve a steep learning curve. Often, completion of a development project requires employees to thoroughly document completion of tasks, assignment of work, develop code, and create other electronic work product. These requirements are both time and resource consuming for employees, reducing overall team and individual productivity. Further, some existing technical solutions are platform-specific and are unable to use data from other platforms or easily provide results to these other platforms.

The systems and techniques described herein are directed to an automation service that can be executed within a collaboration platform in order to generate content or perform other actions within the collaboration platform. The automation service may also invoke one or more automated assistant services, which may be leveraged from a generative interface like an automated chat service.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system that includes a centralized automation rule service for the creation of automation rules.

FIG. 2 depicts an example system for providing content generation services with a set of automated assistant services.

FIGS. 3A-3B depict example user interfaces of a documentation platform having a generative interface.

FIG. 3C depicts an example user interface of an issue tracking platform having a generative interface.

FIG. 4 depicts an example frontend interface that supports automation rule creation and automated content assessment for collaboration platforms.

FIG. 5 depicts an example frontend interface that supports automation rule creation and automated content assessment for collaboration platforms.

FIG. 6 depicts an example frontend interface that supports automation rule creation and automated content assessment for collaboration platforms.

FIG. 7 depicts an example frontend interface that supports automation rule creation and automated content assessment for collaboration platforms.

FIGS. 8A-8B depict an example frontend interface for creating automation components specifying respective automated assistant services for use in an automation rule.

FIGS. 9A-9B depict an example frontend interface for generating an automation rule having automated assistant services.

FIG. 10 depicts an example frontend interface for generating an automation rule configured to generate content of the collaboration platform.

FIG. 11 depicts an example frontend displaying content generated using an automation rule, described herein.

FIG. 12 depicts an example profile of an automated assistant service, as described herein.

FIG. 13 depicts an example frontend interface including a definition of an automation component for generating structured data object, as described herein.

FIG. 14A depicts an example process for generating an automation component.

FIG. 14B depicts

[symbol]

FIG. 15 depicts a system diagram and network/communication architectures that may support a system as described herein.

FIG. 16 depicts a functional system diagram of network/communication architectures that may support a system as described herein.

FIG. 17 depicts a simplified system diagram and data processing pipeline.

FIG. 18 depicts a system providing multiplatform prompt management as a service.

FIG. 19 shows a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems, devices, and methods for generating and executing automation rules within collaboration platforms, such as documentation systems, issue tracking systems, project management platforms, and the like. As described herein, the automation rules may invoke or utilize one or more automated assistant services, also referred to herein as chat-bot services, which may be used to perform one or more operations of the automation rule. As also described herein, the automated assistant services may be configured to provoke a generative response from a generative output engine, which may include a large-language model or other similar generative content engine. The prompts used to provide the generative response may be defined and edited using an automation generation interface, which allows the user to customize automation components for performing a particular task or set of tasks.

Generally, collaboration platforms can be used to generate, store, and organize user-generated content. As described herein, a collaboration platform or service may include an editor that is configured to receive user input and generate user-generated content that is saved as a content item. The terms “collaboration platform” or “collaboration service” may be used to refer to a documentation platform or service configured to manage electronic documents or pages created by the system users, an issue tracking platform or service that is configured to manage or track issues or tickets in accordance with an issue or ticket workflow, a source code management platform or service that is configured to manage source code and other aspects of a software product, a manufacturing resource planning platform or service configured to manage inventory, purchases, sales activity or other aspects of a company or enterprise. The examples provided herein are described with respect to an editor that is integrated with the collaboration platform. In some instances, the functionality described herein may be adapted to multiple platforms or adapted for cross-platform use through the use of a common or unitary editor service. For example, the functionality described in each example is provided with respect to a particular collaboration platform, but the same or similar functionality can be extended to other platforms by using the same editor service. Also, as described above a set of host services or platforms may be accessed through a common gateway or using a common authentication scheme, which may allow a user to transition between platforms and access platform-specific content without having to enter user credentials for each platform.

An automation rule (which may also be referred to as “automated rules,” or simply “rules”) is an automated workflow that is generally constructed in a “if this, then that” format. Typically, for example a collaboration platform, an automation rule results in the performance of an action upon the occurrence of a trigger, if certain conditions are met. In a collaboration platform, each automation rule is made by combining different types of components, including triggers and actions. An automation rule typically also includes a condition. Branches may also be used in some cases. As used herein, automation rules begin with a trigger (which may also be referred to as a trigger component), the trigger being the catalyst that sets the execution of a rule in motion. In one or more embodiments, a condition (which may also be referred to as a condition component) may also be used, where the condition is a limit on the scope of the automation rule. For example, a condition may require that the rule may only be run when the action that initiated the trigger was performed by a certain user or group of users. As used herein, an action (or action component) is what the rule does or performs, for example what happens when the trigger (and conditions if applicable) is met. In some embodiments, an automation rule may also include a branch. A branch expands the performance or execution of a rule by adding a secondary path (a branch). As used herein, a branch is a sequence of conditions and/or actions that run in isolation from the rest of the rule, but are applied to each (e.g., every) instance of an object. For example, the rule for each task (e.g., an object) can be branched so that a message is sent to a recipient every time a person is mentioned on a particular page (e.g., when such page is published). This branch action occurs in addition to any action on the primary path of the automation rule chain.

In some cases, a collaboration platform may include a large amount of content to be managed. Certain tasks may require many repetitive actions or a person responsible for managing content may not realize that an action needs to be performed to manage the content. As such, a collaboration platform may benefit from allowing users to establish automation rules to automatically perform such tasks that would otherwise need to be performed manually. Such automation rules can reduce management overhead, saving time and freeing up resources, and add management consistency, increasing transparency and organization, while reducing errors.

As described herein, system users or content creators may create and execute custom automation rules that can be used to automatically perform a set of tasks or actions. The automation rule may include a set of components that are executed in sequence in response to a trigger condition being satisfied. Each of the components may perform a set of instructions, some of which may be specified by the creator of the automation rule. However, some traditional automation components have a relatively focused or specialized set of actions that can be performed. It may be beneficial to have components that provide a greater amount of adaptability and flexibility to cover a wider range of conditions. It may also be beneficial to have components that are able to automatically generate content for the collaboration platform in a way that mimics other user-generated content.

As described herein, the proposed automation service allows for the use of automated assistant services to be referenced and used by user-defined automation components. The automated assistant services may be selected from a set of services that are provided by the collaboration platform and may be the same automated assistant services that are used to conduct automated chat operations with the system users. In some cases, the automated assistant services may also be referred to as chatbots, artificial-intelligence agents, or service agents. As described herein, the automated assistant services may be specialized services that are able to draw from a set of system resources including electronic documents and pages, and specialized functions in order to construct custom prompts that are provided to a generative output engine, which includes a large-language model or other similar generative content engine. In response, the generative output engine may produce a unique generative response, which is returned by the automated assistant service. In an automated chat implementation, the generative response may be produced as a generated message in a chat session. However, if adapted for use in an automation rule, the generative response may be returned as the output of the respective automation component. This allows the automation service to leverage a broad range of specialized automated assistant services, which may be selected by a user to perform one or more tasks of a custom automation rule. Additionally, as described herein, the automation components may allow the user to define a natural language command text string, which may be used by the automated assistant service when generating the respective prompt and allow the user to provide more specific instructions or guidance with respect to the automated assistant service output. Other controls including temperature (e.g., output variability), tone, response length, acceptance criteria, and other constraints on the automated assistant service output may also be provided by the user in the component definition.

As described herein, multiple automated assistant services may be used in a single automation rule. The output of one automated assistant service-based component may be used as input to another automated assistant service-based component, which may allow for more complex and sophisticated automation rules. However, as the output of a first automated assistant service is fed to one or more additional automated assistant services, variability in each automated assistant service output may result in wide variations in the output of the automation rule or may become unresolvable by the automation rule. In order to reduce variability and improve consistency of results over multiple executions of the automation rule, the system may use specialized components that may produce a structured data object that represents the generated response produced by a respective automated assistant service. For example, a natural language generative response may be converted into or represented by the structured data object, which may be formatted in accordance with a predefined schema or format. In some cases, the structured data object is formatted as a JSON or other similarly formatted data object. As described herein, the specialized component may itself specify or utilize a specialized automated assistant service that is adapted to produce a structured data object in response to a natural language string input. The use of intermediate structured data objects between a chain of two or more automated assistant services may improve the consistency and reliability of the respective automation rule.

Further, using a user-defined automation rule, content may be generated in the collaboration platform by one or more of the automated assistant services invoked by the automation rule. In some implementations, the content created by an automated assistant service is attributed to the automated assistant service rather than to the creator of the automation rule or another system user. Attribution may be displayed in the collaboration platform using an avatar or other graphical element that represents the content author. In some cases, if the content is a comment or message, the attribution is displayed as the comment or message sender, which may be designated with an avatar, creator name, or other visual indicia. The attribution to the automated assistant service helps to reduce the amount of content that appears to be generated by a particular system user, which may otherwise be the creator of the automation rule. The attribution also puts other users on notice that a generative engine or artificial intelligence service helped to create the content.

While attribution may be associated with the automated assistant service for content creation or actions, the automated assistant service may be limited by the permissions scheme of the automation rule creator in order to maintain existing security and privacy policies and protocol. That is, the automated assistant service may not be permitted to create content or take action in a way that the creator of the automation rule could not do manually. Thus, as described herein, the automated assistant service may, when being executed as part of an automation rule, may assume the permissions role or profile of the user that generated the automation rule. In some cases, the automated assistant service operates under a permissions scheme that is at least more restrictive than the permissions scheme permitted for the creator of the automation rule.

As described herein, an automated assistant service may have a user-profile within the collaboration platform. The user profile may include information about the system activity attributed to the automated assistant service, which may include a log or summary of events or system activity. As described in examples herein, the automated assistant service user profile may also include configuration information including editable instructions or prompt language that may be modified in order to alter or change the behavior or output produced by the automated assistant service.

The proposed automation service may leverage existing automated assistant services, which may also be leveraged by another aspect of the system like a generative chat service or generative chat interface. Generally, content identification, content generation, and content management of a suite of software platforms may be accomplished using an automated assistant service, as described herein. In some implementations, the automated assistant services may be integrated with a chat-based interface allowing a user to submit queries and invoke actions using a natural language conversational format. A natural language user input may be analyzed to determine an action intent or other indication of the class of operations or type of expertise that may correlate to the user input. In response to the action intent correlating with a particular subject-matter expertise, set of functions or a work domain, a respective automated assistant service may be invoked. The action intent may be evaluated with respect to one or more characteristics of a respective automated assistant service in order to select the service for providing a response to the user input. For example, the one or more characteristics of the automated assistant service may include subject-matter expertise, functional feature set, work domain scope, field of operation or other characteristic that is predicted to correspond to the user's request. In some cases, the characteristics are defined, at least in part, by a set of plugins that are utilized by or registered with the respective automated assistant service. Additionally or alternatively, the characteristics may be defined, at least in part, by a knowledge base or set of resources utilized by or registered with the respective automated assistant service. The characteristics may also be defined, at least in part, by the predetermined prompt text associated with the respective automated assistant service. In order to facilitate evaluation, a set of keywords, phrases or a vectorization of a set of words may be used as a representation of the distinct characteristics of the automated assistant service. The amount of correlation or degree of correspondence between a user input (or resulting action intent) may be determined using a natural language comparison technique including, for example, a cosine similarity, Levenshtein distance, Jaccard similarity or other semantic technique. In some cases, a trained model is used to determine the amount of correlation or degree of correspondence between a user input (or action intent) and characteristics of the automated assistant service. Example trained models may include transformer machine-learning models that are adapted to operate on semantic representations including tokenized sets, vector representations, embeddings, or other techniques used to represent semantic elements.

In some instances, the assistant services may be invoked or implemented in series and the output from one assistant may be further processed by another assistant. In this way, compound actions involving multiple assistant services can be executed based on a single natural language user input. For example, a user input may be analyzed to estimate a likelihood that the user input includes multiple action intents or a compound action intent, which may require multiple assistant services, each having a different set of functions or subject-matter expertise, in order to respond to the user input.

Automatically generated content can supplement, summarize, format, and/or structure existing tenant-owned user-generated content created by a user while operating a software platform, such as described herein. In one embodiment, user-generated content can be supplemented by an automatically generated summary. The generated summary may be prepended to the content such that when the content is rendered for other users, the summary appears first. In other cases, the summary may be appended to an end of the document. In yet other examples, the generated summary may be transmitted to another application, messaging system, or notification system. For example, a generated document summary can be attached to an email, a notification, a chat or ITSM support message, or the like, in lieu of being attached or associated with the content it summarizes.

In another example, user-generated content can be supplemented by automatic insertion of format markers or style classes (e.g., markdown tags, CSS classes, and the like) into the user-generated content itself. In other examples, user-generated content can be rewritten and/or restructured to include more detail, remove unnecessary detail, and/or adopt a more neutral or positive tone. These examples are not exhaustive.

In yet other examples, multiple disparate user-generated content items, stored in different systems or in different locations, can be collapsed together into a single summary or list of summaries.

In addition to embodiments in which automatically generated content is generated in respect of existing user-generated content (and/or appended thereto), automatically generated content as described herein can also be used to supplement API requests and/or responses generated within a multiplatform collaboration environment. For example, in some embodiments, API request bodies can be generated automatically by leveraging systems described herein. The API request bodies can be appended to an API request provided as input to any suitable API of any suitable system. In many cases, an API with a generated body can include user-specific, API-specific, and/or tenant-specific authentication tokens that can be presented to the API for authentication and authorization purposes.

The request bodies, in these embodiments, can be structured so as to elicit particular responses from one or more software platforms' API endpoints. For example, a documentation platform may include an API endpoint that causes the documentation platform to create a new document from a specified template. Specifically, in these examples, a request to this endpoint can be generated, in whole or in part, automatically. In other cases, an API request body can be modified or supplemented by automatically generated output, as described herein.

For example, an issue tracking system may present an API endpoint that causes creation of new issues in a particular project. In this example, string or other typed data such as a new issue titles, new issue state, new issue description, and/or new issue assignee fields can be automatically generated and inserted into appropriate fields of a JSON-formatted request body. Submitting the request, as modified/supplemented by automatically generated content, to the API endpoint can result in creation of an appropriate number of new issues.

In another example, a trouble ticket system (e.g., an information technology service management or “ITSM” system) may include an interface for a service agent to chat with or exchange information with a customer experiencing a problem. In some cases, automatically generated content can be displayed to the customer, whereas in other cases, automatically generated content can be displayed to the service agent.

For example, in the first case, automatically generated content can summarize and/or link to one or more documents that outline troubleshooting steps for common problems. In these examples, the customer experiencing an issue can receive through the chat interface, one or more suggestions that (1) summarize steps outlined in comprehensive documentation, (2) link to a relevant portion of comprehensive documentation, or (3) prompt the customer to provide more information. In the second case, a service agent can be assisted by automatically generated content that (1) summarizes steps outlined in comprehensive documentation and/or one or more internal documentation tools or platforms, (2) link to relevant portions of comprehensive help documentation, or (3) prompt the service agent to request more information from the customer. In some cases, generated content can include questions that may help to further narrowly characterize the customer's problem. More generally, automatically generated content can assist either or both service agents and customers in ITSM environments.

The foregoing embodiments are not exhaustive of the manners by which automatically generated content can be used in multi-platform computing environments, such as those that include more than one collaboration tool.

More generally and broadly, embodiments described herein include systems configured to automatically generate content within environments defined by software platforms. The content can be directly consumed by users of those software platforms or indirectly consumed by users of those software platforms (e.g., formatting of existing content, causing existing systems to perform particular tasks or sequences of tasks, orchestrate complex requests to aggregate information across multiple documents or platforms, and so on) or can integrate two or more software platforms together (e.g., reformatting or recasting user generated content from one platform into a form or format suitable for input to another platform).

### Scalable Network Architecture for Automatic Content Generation

More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input. Many of the examples described herein are directed to an interface that includes a generative interface panel having an input region that can receive commands, references to content, links, and other input, at least a portion of which is provided as natural language text.

In some examples, the user may engage with a button in a UI that causes the generative interface panel or a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task.

Regardless of how a software platform user interface is instrumented to receive user input, the user may provide an input that includes a string of text including a natural language request or instruction (e.g., a prompt). The prompt may be provided as input to an input queue including other requests from other users or other software platforms. Once the prompt is popped from the queue, it may be normalized and/or preconditioned by a preconditioning service. The preconditioning service may be provided by one or more registered plugins that are selected in accordance with an analysis of the input and/or context of the current session.

The preconditioning service can, without limitation: append additional context to the user's raw input; may insert the user's raw input into a template prompt selected from a set of prompts (also referred to herein as “predetermined query prompt text” or “predetermined prompt text”); replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### Large Language Models

An example of a generative output engine of a generative output system as described herein may be a large language model (LLM). An LLM may include a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phrase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. An LLM is typically trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation can be selected or generated using a number of techniques. In many cases, a continuation of an input prompt may be referred to more generally as “generated text” or “generated output” provided by a generative output engine as described herein.

Fundamentally all written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=′https://example link/123456>project 123456</a>”. In addition, the LLM may be configured to replace the substring “pending” with a real-time updating token associated with an API call to the project management system. In this manner, the LLM converts a static string within the document management system into richer content that facilitates convenient and automatic cross-linking between software products, and may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilitates bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of attention mechanisms, including self-attention mechanisms, may be suitable.

In response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations. In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoint, such as for configuration or for receiving input prompts. The generative output application can be further configured to provide generated text output to one or more subscribers or API clients. Many suitable interfaces can be configured to provide input to and receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:
{
   “prompt”: “Generate five words of placeholder text in the English language.”,
   “API_KEY: “hx-Y5u4zx3kaF67AzkXK1hC”,
   “user_token”: “PkcLe7Co2G-50AoIVojGJ”
}

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:
{
   “response”: “Hello world text goes here.”,
   “generation_time_ms”: 2
}

In some embodiments, a prompt provided as input to a generative output engine can be engineered from user input. For example, in some cases, a user input can be inserted into an engineered template prompt that itself is stored in a database and includes text that may be referred to as predetermined query prompt text or predetermined prompt text. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, a prompt received from a user can be preconditioned and/or parsed to extract certain content therefrom. The extracted content can be used to inform selection of a particular engineered prompt template from a database of engineered prompt templates including predetermined query prompt text or predetermined prompt text. Once the selected prompt template is selected, the extracted content can be inserted into the template to generate a populated engineered prompt template that, in turn, can be provided as input to a generative output engine as described herein. Content extraction, prompt configuration, and prompt selection may be performed by a processing plugin that is registered or otherwise available to a generative service.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance,” “prompt preconditioning software instance,” “processing plugin,” or “plugin”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences.

For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on. For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:
{
   “raw_prompt”: summarize the edits to this page made by my team since I last visited this page”,
   “modified_prompt”: “Generate a summary of each paragraph tagged with an editId attribute matching editId=1, editId=51, editId=165, editId=99 within the following HTML-formatted content: [HTML-formatted content of the page].”
}

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:
{
   “snippet123_table_from_tasks”: “The table should be formatted as a three-column table with multiple rows. The leftmost column should be titled ‘Title’ and the corresponding content of each row of this column should be the title attribute of a task. The middle column should be titled ‘Created Date’ and the corresponding content of each row of this column should be the creation date of the task. The rightmost column should be titled ‘Status’ and the corresponding content of each row of this column should be the status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:
{
   “modified_prompt”: “Find all tasks assigned to User 1234 dating from Jan. 1, 2023-Jan. 14, 2023 (inclusive). Create a table in which each found task corresponds to a respective row of that table. The table should be formatted as a markdown table, in plain text, with three columns. The leftmost column should be titled ‘Title’ and the corresponding content of each row of this column should be the title attribute of a respective task. The middle column should be titled ‘Created Date’ and the corresponding content of each row of this column should be the creation date of the respective task. The rightmost column should be titled ‘Status’ and the corresponding content of each row of this column should be the status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents.

In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url”.

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein. More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated With Generative Output Systems

In particular, embodiments described herein are focused to leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. For example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems. For example, a documentation system can leverage a generative output engine to, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multitenant software platform.

For simplicity of description, the multitenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform—multitenant or otherwise—as described herein are not collocated, and communicate over a large area and/or wide area network by leveraging one or more networking protocols, but this is not required of all implementations.

A frontend of a software platform as described herein may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multitenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third-party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multitenant software and, in particular, by a provider of suites of multitenant software platforms, each platform being configured for a different particular purpose. Herein, providers of systems or suites of multitenant software platforms are referred to as “multiplatform service providers.” Generally, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multitenant issue tracking system, a multitenant code repository service, and a multitenant documentation service. In this example, an organization that is a customer/client of the service provider may be a tenant of each of the issue tracking system, the code repository service, and the documentation service.

As with preceding examples, the organization can create and/or purchase user accounts for its employees, so that certain selected employees have access to one or more of issue tracking functionality, documentation functionality, and code repository functionality.

In this example and others, a system may leverage multiple collaboration tools to advance individual projects or goals. For example, for a single software development project, a software development team may use (1) a code repository to store project code, executables, and/or static assets, (2) a documentation service to maintain documentation related to the software development project, (3) an issue tracking system to track assignment and progression of work, and (4) a messaging service to exchange information directly between team members.

However, as organizations grow, as project teams become larger, and/or as software platforms mature and add features or adjust user interaction paradigms over time, using multiple software platforms can become inefficient for both individuals and organizations. To counteract these effects, many organizations define internal policies that employees are required to follow to maintain data freshness across the various platforms used by an organization.

For example, when a developer submits a new pull request to a repository service, that developer may also be required by the organization to (1) update a description of the pull request in a documentation service, (2) change a project status in a project management application, and/or (3) close a ticket in a ticketing or issue tracking system relating to the pull request. In many cases, updating and interacting with multiple platforms on a regular and repeating basis is both frustrating and time consuming for both individuals and organizations, especially if the completion of work of one user is dependent upon completion of work of another user.

Some solutions to these and related problems often introduce further issues and complexity. For example, many software platforms include an in-built automation engine that can expedite performance of work within that software platform. In many cases, however, users of a software platform with an in-built automation engine may not be familiar with the features of the automation engine, nor may those users understand how to access, much less efficiently utilize, that automation engine. For example, in many cases, accessing in-built automation engines of a software platform requires diving deep into a settings or options menu, which may be difficult to find.

Other solutions involve an inter-platform bridge software that allows data from one platform to be accessed by another platform. Typically, such bridging software is referred to as an “integration” between platforms. An integration between different platforms may allow content, features, and/or functionality of one platform to be used in another platform.

For example, a multiplatform service provider may host an issue tracking system and a documentation system. The provider may also supply an integration that allows issue tracking information and data objects to be shown, accessed, and/or displayed from within the documentation system. In this example, the integration itself needs to be separately maintained in order to be compliant with an organization's data sharing and/or permissions policies. More specifically, an integration must ensure that authenticated users of the documentation system that view a page that references information stored by the issue tracking system are also authorized to view that information by the issue tracking system.

Phrased in a more general way, an architecture that includes one or more integrations between tenancies of different software platforms requires multiple permissions requests that may be forwarded to different systems, each of which may exhibit different latencies, and have different response formats, and so on. More broadly, some system architectures with integrations between software platforms necessarily require numerous network calls and requests, occupying bandwidth and computational resources at both software platforms and at the integration itself, to simply share and request information and service requests for information by and between the different software platforms. This architectural complexity necessitates careful management to prevent inadvertent information disclosure.

Furthermore, the foregoing problem(s) with maintaining integrations' compliance with an organization's policies and organization-owned content access policies may be exacerbated as a provider's platform suite grows. For example, a provider that maintains three separate platforms may choose to provide three separate integrations interconnecting all three platforms. (e.g., 3 choose 2). In this example, the provider is also tasked with maintaining policy compliance associated with those three platforms and three integrations. If the provider on-boards yet another platform, a total of six integrations may be required (e.g., 4 choose 2). If the provider on-boards a fifth platform, a total of ten integrations may be required (e.g., 5 choose 2). Generally, difficulties of maintaining integrations between different software platforms (in a permissions policy compliant manner) scales exponentially with the number of platforms provided.

Further to the inadvertent disclosure risk and maintenance obligations associated with inter-platform integrations, each integration is still only configured for information sharing, and not automation of tasks. Although context switching to copy data between two integrated platforms may be reduced, the quantity of tasks required of individual users may not be substantially reduced.

Further solutions involve creating and deploying dedicated automation platforms that may be configured to operate with one, and/or perform automations of, or more platforms of a multiplatform system. These, however, much like automation engines in-built to individual platforms, may be difficult to use, access, or understand. Similarly, much like integrations described above, dedicated automation platforms require separate maintenance and employee training, in addition to licensing costs and physical or virtual infrastructure allocations to support the automation platform(s).

In still further other circumstances, many automations may take longer for a user to create than the time saved by automating that particular task. In these examples, individual users may avoid defining automations altogether, despite that, in aggregate, automation of a given task may save an organization substantial time and cost.

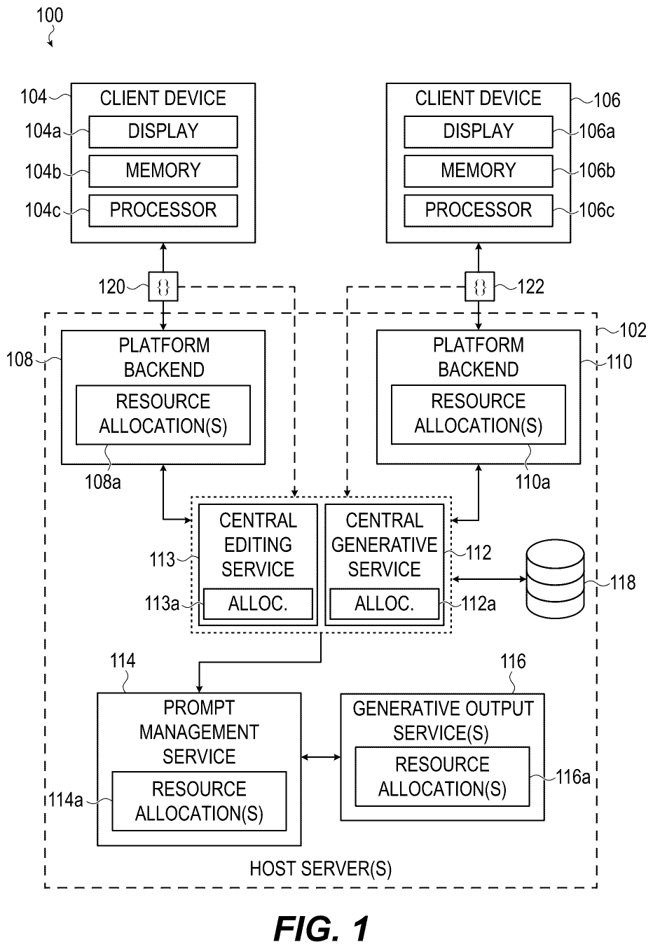

These foregoing and other embodiments are discussed below with reference to FIGS. 1-19. However, the detailed description given herein with respect to these figures is for explanation only and should not be construed as limiting.

FIG. 1 depicts a simplified diagram of a system, such as described herein that can include and/or may receive input from a generative output engine as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include ITSM systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system, as well.

A user of the client devices may trigger production of generative output in a number of suitable ways. One example is shown in FIG. 1. In particular, in this embodiment, each of the software platforms can share a common feature, such as a common generative service, which may be rendered in a frame of the frontend user interfaces of both platforms.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each communicably couple to a centralized generative service 112.

The centralized generative service 112 can be configured to cause rendering of a frame or panel within respective frontends of each of the first platform backend 108 and the second platform backend 110. In this manner, and as a result of this construction, each of the first platform and the second platform present a consistent user content editing experience for accessing generative services including the automated assistant services and other operations described herein.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized generative service 112 that can be called by each respective frontend whenever it is required to present the user of that respective frontend with a generative interface that may facilitate a chat-based exchange with one or more automated assistant services.

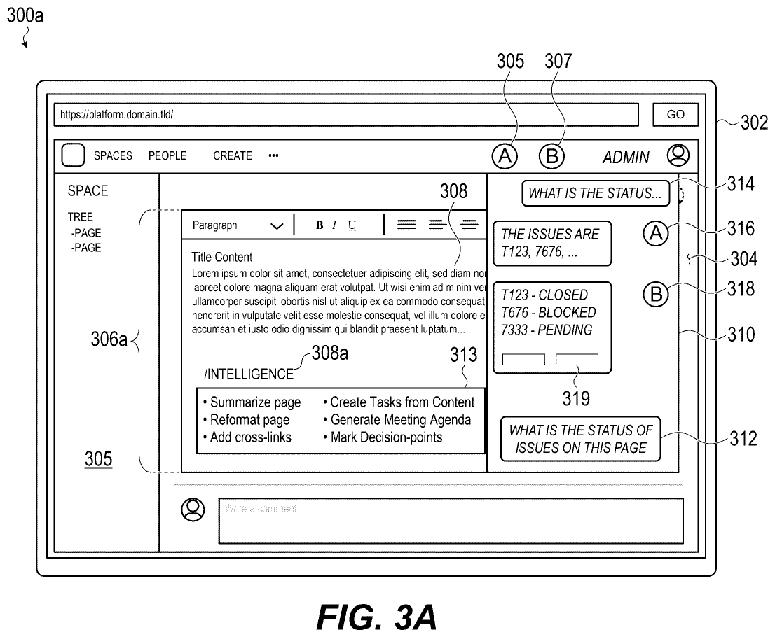

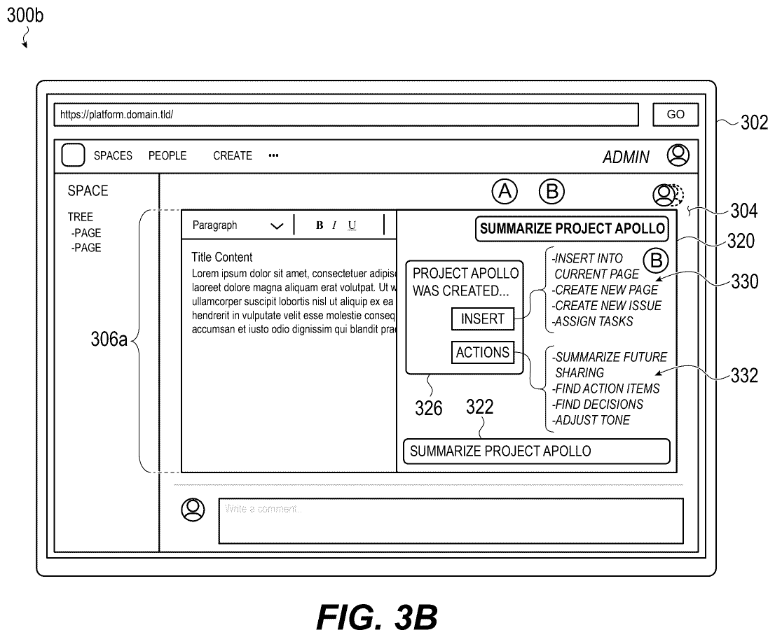

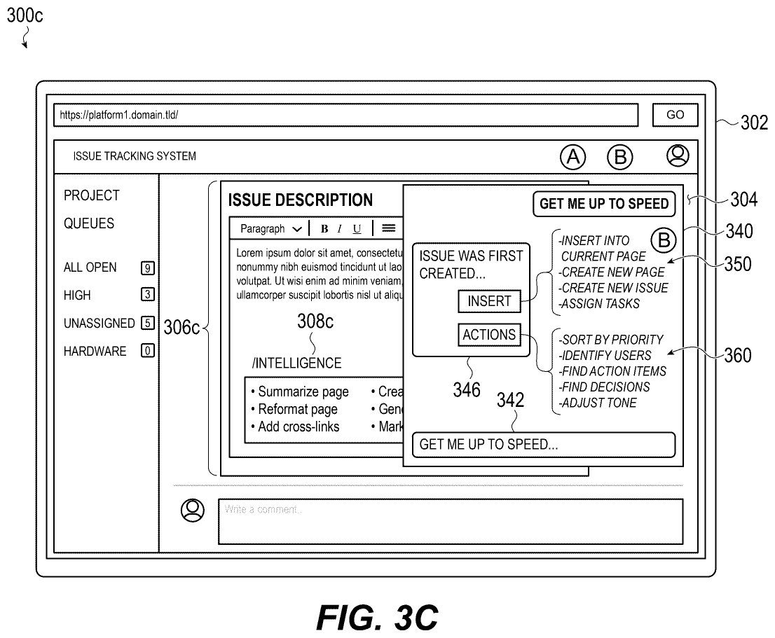

The documentation platform's frontend may call upon the centralized generative service 112 to assist with content discovery and creation with respect to pages or documents managed by the documentation platform. (See, e.g., FIG. 3A.) Similarly, the issue tracking platform's frontend may call upon the centralized generative service 112 to perform content discovery, generation, and management of issues or tickets managed by the issue tracking platform.

The system 100 may also include a centralized content editing frame service 113, which can operate an editor or editing service for each of multiple platforms. More specifically, the centralized content editing frame service 113 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor. The centralized content editing frame service 113 can parse text input provided by users of the documentation platform frontend and/or the issue tracking platform backend, monitoring for command and control keywords, phrases, trigger characters, and so on. In many cases, for example, the centralized content editing frame service 113 can implement a slash command service that can be used by a user of either platform frontend to issue commands to the backend of the other system.

For example, the user of the documentation platform frontend can input a slash command to the content editing frame, rendered in the documentation platform frontend supported by the centralized content editing frame service 113, in order to type a prompt including an instruction to create a new issue or a set of new issues in the issue tracking platform. Similarly, the user of the issue tracking platform can leverage slash command syntax, enabled by the centralized content editing frame service 113, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; content editing elements can include and/or may be implemented to include many features, which may vary from embodiment to embodiment. For simplicity of description the embodiments that follow reference a centralized content editing frame service 113 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized content editing frame service 113 can be extended to include additional features and functionality—such as a slash command and control feature—which, in turn, can automatically be leveraged by any further platform that incorporates a content editing frame, and/or otherwise integrates with the centralized content editing frame service 113 itself. In this example, slash commands facilitated by the editor service can be used to receive prompt instructions from users of either frontend. These prompts can be provided as input to a prompt engineering/prompt preconditioning service (such as the prompt management service 114) that, in turn, provides a modified user prompt as input to a generative output service 116.

Similar functionality can also be provided by the centralized generative service 112. For example, as described herein the centralized generative service 112 may provide a chat-based interface in a panel or region of a frontend application. Through a series of natural language inputs, the system may provide content discovery, content modification, content generation, or content management operations. In some cases, the centralized generative service 112 utilizes a variety of software plugins and/or automated assistant services to provide the requested operations. The centralized generative service 112 may generate prompts, which, in this example, can be provided as input to a prompt engineering/prompt preconditioning service (such as the prompt management service 114) that, in turn, provides a modified user prompt as input to a generative output service 116.

The generative output service may be hosted over the host servers 102 or, in other cases, may be a software instance instantiated over separate hardware. In some cases, the generative engine service may be a third-party service that serves an API interface to which one or more of the host services and/or preconditioning service can communicably couple. The generative output engine can be configured as described above to provide any suitable output, in any suitable form or format. Examples include content to be added to user-generated content, API request bodies, replacing user-generated content, and so on.

The centralized content editing frame service 113 and/or the centralized generative service 112 can be configured to provide suggested prompts to a user as the user types. For example, as a user begins typing a slash command in a frontend of some platform that has integrated with a centralized content editing frame service 113 as described herein, the centralized content editing frame service 113 can monitor the user's typing to provide one or more suggestions of prompts, commands, or controls (herein, simply “preconfigured prompts”) that may be useful to the particular user providing the text input. Similarly, the centralized generative service 112 may monitor the user's typing and provide one or more suggestions of prompts, commands, or controls. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized content editing frame service 113 and/or the centralized generative service 112 can be configured to suggest one or more prompts that can be provided as input to a generative output engine as described herein to perform a useful task, such as summarizing content rendered within the centralized content editing frame service 113, reformatting content rendered within the centralized content editing frame service 113, inserting cross-links within the centralized content editing frame service 113, and so on.

The ordering of the suggestion list and/or the content of the suggestion list may vary from user to user, user role to user role, and embodiment to embodiment. For example, when interacting with a documentation system, a user having a role of “developer” may be presented with prompts associated with tasks related to an issue tracking system and/or a code repository system. Alternatively, when interacting with the same documentation system, a user having a role of “human resources professional” may be presented with prompts associated with manipulating or summarizing information presented in a directory system or a benefits system, instead of the issue tracking system or the code repository system. More generally, in some embodiments described herein, a centralized content editing frame service 113 and/or the centralized generative service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content editing frame service 113 and/or the centralized generative service 112, as described herein, can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein reference systems and methods for sharing user interface elements rendered by a centralized content editing frame service 113 and features thereof (such as a slash command processor), between different software platforms in an authenticated and secure manner. For simplicity of description, the embodiments that follow reference a configuration in which a centralized content editing frame service is configured to implement a slash command feature—including slash command suggestions—but it may be appreciated that this is merely one example and other configurations and constructions are possible. Similarly, the centralized generative service 112 may be configured to implement a variety of commands initiated using a command character (e.g., a slash, @, or other special symbol), can be used to invoke various assistant services, plugins, or other operations from the generative interface.

The first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized content editing frame service 113 and the centralized generative service 112. Information can be transacted by and between the frontend, the first platform backend 108 and the centralized content editing frame service 113 and the centralized generative service 112 in any suitable manner, form, or format. In many embodiments, as noted above, the client device 104 and in particular the first platform frontend can be configured to send an authentication token 120 along with each request transmitted to any of the first platform backend 108 or the centralized content editing frame service 113, the centralized generative service 112, the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized content editing frame service 113 and the centralized generative service 112. Information can be transacted by and between the frontend, the second platform backend 110 and the centralized content editing frame service 113 and the centralized generative service 112 in any suitable manner, form, or format. In many embodiments, as noted above, the client device 106 and in particular the second platform frontend can be configured to send an authentication token 122 along with each request transmitted to any of the second platform backend 110 or the centralized content editing frame service 113 and the centralized generative service 112.

As a result of these constructions, the centralized content editing frame service 113 and the centralized generative service 112 can provide uniform feature sets to users of either the client device 104 or the client device 106. For example, the centralized content editing frame service 113 can implement a slash command processor to receive prompt input and/or preconfigured prompt selection provided by a user of the client device 104 to the first platform and/or to receive input provided by a different user of the client device 106 to the second platform.

The centralized content editing frame service 113 and the centralized generative service 112 may ensure that common features are available to frontends of different platforms. One such class of features provided by the centralized content editing frame service 113 and the centralized generative service 112 invokes output of a generative output engine of a service such as the generative engine output service 116.

For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized content editing frame service 113 and the centralized generative service 112. The user input may include a prompt to be continued by the generative output service 116.

The prompt management service 114 can be configured to modify the user input, to supplement the user input, select a prompt from a database (e.g., the database 118) based on the user input, insert the user input into a template prompt, replace words within the user input, perform searches of databases (such as user graphs, team graphs, and so on) of either the first platform backend 108 or the second platform backend 110, change grammar or spelling of the user input, change a language of the user input, and so on. The prompt management service 114 may also be referred to herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized content editing frame service 113 or the centralized generative service 112 to return to a suitable backend application, to in turn return to or perform a task for the benefit of a client device such as the client device 104 or the client device 106. More particularly, it may be appreciated that although FIG. 1 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized content editing frame service 113, the centralized generative service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative output service 116.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to ${user} with a due date in the next 2 days.” In this example, the token/field/variable ${user} can be replaced with a user identifier corresponding to the user currently operating a client device. The templatized prompts or the static portions thereof may be referred to as predetermined query prompt text or predetermined prompt text.

This insertion of an unambiguous user identifier can be performed by the client device, the platform backend, the centralized content editing frame service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user123 with a due date in the next 2 days” can be retrieved from a database or other memory, and provided as input to the generative output service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt}. Provide output of any table in the form of a tab delimited table formatted according to the markdown specification.” In this example, the variable ${user prompt} may be replaced with the user prompt such that the entire prompt received by the generative output service 116 can include the user prompt and the example sentence describing how a table should be formatted.

In yet other embodiments, a suggestion may be generated by the generative output service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative output service 116 may generate a set of JSON objects that, when received by the Kanban platform, are rendered as a set of cards in a Kanban board, each card including a different title and description corresponding to different tasks that may be associated with steps for creating a new iced cream flavor. In this manner, the user can quickly be presented with an example set of initial tasks for a new project.

In yet other examples, suggestions can be configured to select or modify prompts that cause the generative output service 116 to interact with multiple systems. For example, a suggestion in a documentation system may be to create a new document content section that summarizes a history of agent interactions in an ITSM system. In some cases, the generative output service 116 can be called more than once and/or it may be configured to generate its own follow-up prompts or prompt templates which can be populated with appropriate information and re-submitted to the generative output service 116 to obtain further generative output. More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. Many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a. Similarly, the second platform backend 110 may be instantiated over the resource allocations 110a (including processors, memory, storage, network communications systems, and so on). The centralized content editing frame service 113 is supported by a processor and memory and network connection (and/or database connections) collectively represented for simplicity as the resource allocations 113a. The centralized generative service 112 is supported by a processor and memory and network connection (and/or database connections) collectively represented for simplicity as the resource allocations 112a. The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generative output systems, as described herein, should not be usable to obtain information from an organizations datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect keywords or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized content editing frame service 113 or a centralized generative service 112.

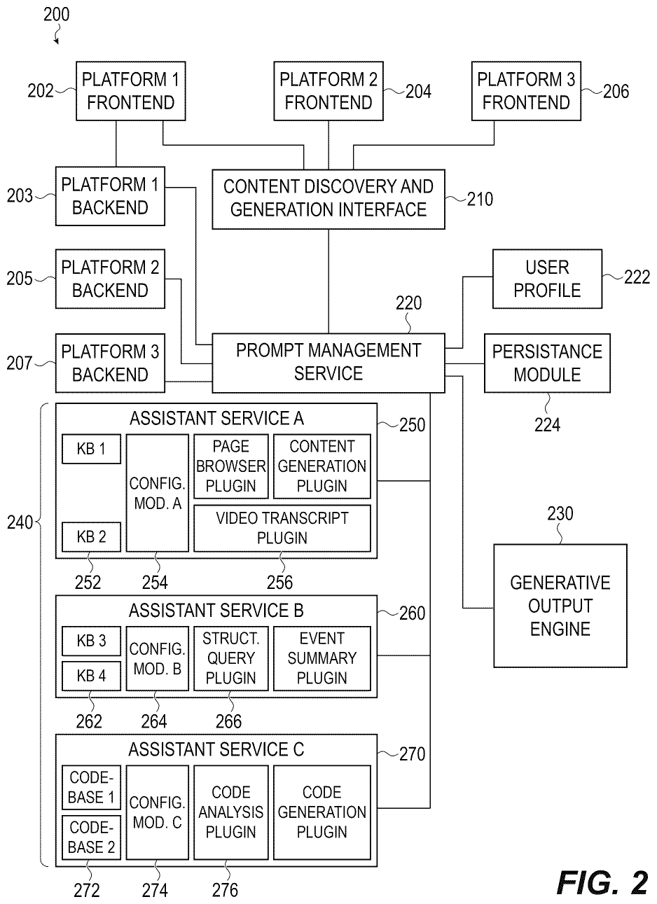

FIG. 2 depicts another example system 200 that can be used to provide a content generation service. More specifically, the system 200 can be used to provide generative services including automated assistant services that can be used across multiple software platforms. As described herein, the automated assistant services may be invoked as part of a generative interface (e.g., a chat service or interface) or may be invoked as part of an automation service as part of an automation rule or sequence. The system 200 of FIG. 2 may be implemented using the networked system 100 of FIG. 1. In particular, one or more client devices operating an application frontend may be communicatively or operably coupled to a backend of a content collaboration platform or other platform service. In the example system 200, each of the frontend applications 202, 204, 206 are each operably coupled to a respective backend application 203, 205, 207. In the diagram of FIG. 2, an example connection between frontend application 202 and backend application 203 is depicted. Other couplings between frontend applications 204, 206 and backend applications 205, 207 are omitted in this figure for clarity. Similar to other examples described herein, the frontend applications 202, 204, 206 provide graphical user interfaces for a collaboration platform or other platform provided by the respective backend applications 203, 205, 207. The backend applications 203, 205, 207 may each provide a different platform including, without limitation, documentation platforms, issue tracking platforms, user and project directory platforms, source code management systems or platforms, project management or project tracking platforms, and other platforms. The system 200 omits some elements described elsewhere in the specification in order to improve clarity and to reduce redundancy.

As shown in FIG. 2, multiple frontend applications 202, 204, and 206 may have access to a common or shared content discovery and generation interface 210. As shown in the example user interfaces described herein, a common generative service may be instantiated or invoked from within one of a number of different frontend applications 202, 204, and 206, which causes display of the content discovery and generation interface. In many of the examples described herein, the content discovery and generation interface includes a generative interface panel that may be displayed concurrently with content of one of the frontend applications 202, 204, and 206, which may be positioned alongside the content or may overlap or overlay existing content. The content discovery and generation interface 210 may be provided as a web plugin to a browser application or may be integrated with a web-enabled frontend application. Depending on the implementation or particular use case, each of the frontend applications 202, 204, and 206 may be operating on the same client device or may be operating on different client devices. In some cases, each of the frontend applications 202, 204, and 206 may be executed or operated by a shared browser client application.

The content discovery and generation interface 210 may include an input region or a field that is configured to receive natural language input, which may include a natural language query, reference to content items, links to content items, and/or reference to earlier queries or results provided in the content discovery and generation interface 210. User input provided to the content discovery and generation interface 210 is provided to a prompt management service 220, which may analyze the natural language to determine an intent and/or platform that corresponds to the user input. In some examples, the prompt management service may include an intent recognition model that is configured to classify the user input as being directed to a class or type of inquiry. The prompt management service 220 may use natural language processing including tokenization and word embedding techniques to convert the natural language input into a multi-dimensional vector or other representation. The processed natural language input may then be provided to the intent recognition model, which has been constructed to provide an intent classification or query classification as an output. The intent recognition model may include a transformer model that has been trained using a corpus of previous user input or queries and associated intent classifications or query classifications. In some cases, the intent recognition model is a bidirectional encoder representation transformer model that has been trained using a training corpus that includes, but it is not limited to, previous interactions with the content discovery and generation interface 210.

The intent, sometimes referred to as an action intent, determined by the prompt management service 220, may be used to select a particular assistant service 240, which may provide the services required to respond to the user input or query. Each assistant service 250, 260, 270 may be associated with a respective subject-matter expertise or specialized set of functional features. The prompt management service 220 may determine or evaluate a degree of correlation between the action intent and a respective subject-matter expertise of a respective assistant service. For example, in some implementations, a subject-matter expertise may be represented by a set of keywords or representative phrases that may be compared with an action intent determined by the intent recognition module of the prompt management service 220. In some cases, the subject-matter expertise of a respective assistant service may be represented by a set of question-answer pairs, which may include previous queries and corresponding results, which can be used to determine the degree of correlation between the action intent and the subject-matter expertise. The question-answer pairs may be stored over time and associated with a user identifier, a team identifier, a site identifier, or associated with the entire tenant. The respective pairs may be stored in response to a positive feedback or input received in response to a previous set of operations or other measure of a successful outcome.

In response to the action intent correlating with a particular subject-matter expertise, set of functions, or a work domain, a respective automated assistant service may be invoked. The action intent may be evaluated with respect to one or more characteristics of a respective automated assistant service in order to select the service for providing a response to the user input. For example, the one or more characteristics of the automated assistant service may include subject-matter expertise, functional feature set, work domain scope, field of operation or other characteristic that is predicted to correspond to the user's request. In some cases, the characteristics are defined, at least in part, by a set of plugins that are utilized by or registered with the respective automated assistant service. Additionally or alternatively, the characteristics may be defined, at least in part, by a knowledge base or set of resources utilized by or registered with the respective automated assistant service. The characteristics may also be defined, at least in part, by the predetermined prompt text associated with the respective automated assistant service. In order to facilitate evaluation, a set of keywords, phrases or a vectorization of a set of words may be used as a representation of the distinct characteristics of the automated assistant service. The amount of correlation or degree of correspondence between a user input (or resulting action intent) may be determined using a natural language comparison technique including, for example, a cosine similarity, Levenshtein distance, Jaccard similarity or other semantic technique. In some cases, a trained model is used to determine the amount of correlation or degree of correspondence between a user input (or action intent) and characteristics of the automated assistant service. Example trained models may include transformer machine-learning models that are adapted to operate on semantic representations including tokenized sets, vector representations, embeddings, or other techniques used to represent semantic elements.

Each of the assistant services 240 includes a unique set of resources and capabilities that define the assistant service's ability to service a given user query or input. As shown in the example of FIG. 2, a first assistant service 250 may be specially adapted for providing documentation assistance and may be adapted to provide content summaries, project decisions, project or meeting task lists, generate content adapted for a particular use case, provide documentation-focused searches, and perform other operations with respect to a documentation platform. In some implementations, the assistant service 250 may also be adapted to perform cross-platform functionality and enable analysis and content creation for external content items. The assistant service 250 may also be able to call one or more of the other assistant services 260, 270 to perform operations or functionality as part of a compound request or for more complex multi-stage operations.

In the present example, the assistant service 250 includes a configuration module 254 that includes predetermined prompt text (also referred to as predetermined query prompt text) that is used to respond to user input and also used to formulate prompts that are ultimately transmitted to the generative output engine 230 via the prompt management service 220. The predetermined prompt text may be specially configured to provoke a generative response that is directed to a particular subject matter or purpose within the documentation platform. For example, the predetermined prompt text may include example input-output pairs that mirror a desired response style or format for use with the documentation platform. The predetermined prompt text may also include stylistic qualities for a tone or level of detail that is preferred in a generative response. The style, tone, and response type that is generated using the predetermined prompt text and other attributes of the configuration module 254 may define a distinct interaction quality of the assistant service 250. In some cases, the configuration module 254 also includes a designation of one or more large-language modules or other resources that can be used by the prompt management service 220 to service the constructed prompts or queries.

The configuration module 254 may also include a decision engine, which may include code or scripts for defining a sequence of reasoning and retrieval actions, which may be used to propose and evaluate alternatives. This may also be referred to as a “planning stage” of the decision engine. The decision engine may also be adapted to execute one or more of the proposed actions during an “execution stage.” In some cases, the decision engine may leverage previous interactions and an interaction with a positive result may be used in response to a current or subsequent set of proposed actions.

The configuration module 254 may also include a persistence module and/or may leverage the shared persistence module 224 of the system 200, which may be leveraged to improve the accuracy or relevance of the content generated or actions proposed by the assistant service 250. The persistence module 224 and/or the internal persistence of the assistant service 250 may include session-specific memory, which enables the assistant service 250 to reference inputs, references to content items, and generative results that have been used earlier in a current session or in a recent session. This enables the assistant service 250 to address follow-up requests and multi-stage queries in a more natural or conversational fashion without having to repeat criteria, content item references, or other context for purposes of performing further operations or inquiries. As mentioned previously, the persistence module(s) 224 may also include long-term or multi-session memory which may include semantic elements (facts) or episodic elements (past behaviors) that enable the assistant service 250 to improve accuracy or relevancy of the services or better tailor the generative outputs, over time. As mentioned previously, successful outcomes (indicated either expressly through user feedback or implicitly through use of the results) may be stored in the persistence module(s) 224 and used to direct subsequent queries or operations to a similar positive result.

As shown in FIG. 2, each assistant service 250, 260, 270 includes a respective configuration module 254, 264, 274 that is adapted for the subject-matter expertise or specialized operations used for each respective assistant service 250, 260, 270. Each respective configuration module 254, 264, 274 may, for example, include distinct decision engines, persistence modules, predetermined prompt text, and other aspects of the assistant service 250, 260, 270, which may define or help determine the behavior of the service.

Each assistant service 250, 260, 270 may also include additional resources that facilitate the operations performed by the various services. For example, each assistant service 250, 260, 270 may include a set of knowledge base resources 252, 262, 272 that are directed to or relate to the subject-matter expertise of the respective assistant service 250, 260, 270. Resources 252, 262, 272 (e.g., knowledge base resources) may include a corpus of electronic resources including electronic pages, documents, databases, and other content that is searchable or otherwise accessible to the respective service. As shown in the present example some resources 272 may also include code base or code resources, which may include source code, scripts, code libraries, example coding styles or templates and other similar resources. The resources 252, 262, 272 may also include other content items including, for example, issues, tasks, directory entries, example workflows or process flows, and other content items that may be managed by a respective platform. The resources 252, 262, 272 or excerpts thereof may be used to generate prompts that are transmitted to the generative output engine 230 and may help to tailor the focus or quality of the generative response. In some cases, portions of the resources 252, 262, 272 may be used directly for responses to user inputs.

Each assistant service 250, 260, 270 may also include a set of software plugins that are adapted to perform specific functionality with respect to one or more of the platforms. In this specific example, the first assistant service 250 may be directed to a documentation assistant and includes a set of plugins 256 that include a page or document browser plugin that may be adapted to search or locate content and extract portions of the content for use with a prompt or other aspect of the system 200. The set of plugins 256 also includes a content generation plugin, which may be used to create pages, documents, tables, or other content items. The set of plugins 256 also includes a video transcript plugin, which may be used to generate or extract text content from voice, audio, video, or other non-text-based content items.

The second assistant service 260 may be directed to an issue tracking assistant that includes a distinct set of plugins 266. In this example, the set of plugins 266 includes a structured query plugin, which may be adapted to generate and execute structured queries based on natural language prompts. The set of plugins 266 also includes an event summary plugin, which may be used to extract and summarize a series of entries, comments, or events that occur with respect to an issue or other content item.

The third assistant service 270 may be directed to a coding assistant and includes another distinct set of plugins 276. By way of example, the set of plugins 276 may include a code analysis plugin that may be configured to search a codebase and extract portions of source code for analysis or other operations. The plugins 276 may also include a code generation plugin that is adapted to generate code using the specially constructed prompts that are provided to the generative output engine 230. The specially constructed prompts may include example code extracted from the resources 272, code libraries, coding styles and other preferences for generating source code using the generative output engine 230.

The system may also include shared plugins that can be used by various services or directly by the prompt management service 220 in order to provide the required operations. For example, some plugins may provide preprocessing and post-processing on any generative content provided by the generative output engine 230. For example, the system 200 may include remote or external plugins, which may include access to external platforms or system including calendar applications, email platforms, external collaboration platforms, or other services. The system 200 may also include local or core plugins including page access plugins, content search plugins, data graph search plugins, content generation plugins, and others. The system 200 may also include remote internal plugins that may access specific platforms or data sources associated with platforms including a structured query platform, a directory access plugin, and other similar plugins. Each of these plugins may be configured to perform specific pre-processing on the user input, access content from a respective backend application 203, 205, 207 or platform data store in order to assist with an automated prompt generation service provided by the prompt management service 220. Each of the plugins may be registered with the prompt management service 220 and associated with an intent action or other input classifier. In some cases, the plugins are combined or configured for operation in tandem in order to provide a particular service or set of operations.

In general, the prompt management service 220 may direct inquiries to one of the assistant services 250, 260, 270 or to a specific set of software plugins. In some implementations, and as described above, the prompt management service 220 may use an intent analysis module to determine or estimate an intent of a natural language user input. The intent or action intent may indicate a type of action (e.g., class of operations or type of functionality) that is predicted to be needed to respond to the user input. A degree of correlation between the action intent and attributes of the various assistant services 250, 260, 270 may be computed and the service having the highest degree of correlation may be selected to respond to the user input. The attributes of the various assistant services 250, 260, 270 may include specialized operations, resources, or abilities that may be generally characterized as a subject-matter expertise or specialized function set. The correlation may be based on a semantic analysis of text representative of the subject-matter expertise or specialized function set and text of the action intent or other aspects of the natural language user input. If the correlation satisfies a threshold or other rule, the correlation may be determined to satisfy a correlation criteria. Additionally or alternatively, the correlation may be based on previous inputs or results stored in the persistence module 224 or otherwise accessible to the system 200. In some cases, the prompt management service 220 may determine that the action intent includes a compound request or requires multiple assistant services 250, 260, 270 based on a semantic analysis of the natural language user input or based on the action intent corresponding to multiple assistant services 250, 260, 270. In such a scenario, the prompt management service 220 may orchestrate a series of calls to each of the assistant services 250, 260, 270 to perform portions of or aspects of the compound request. The prompt management service 220 may automatically route the output of one service to another service without input from the user. In other cases, user input or confirmation of a first result is received before subsequent assistant services are invoked or employed. The prompt management service 220 may automatically invoke or instantiate a respective assistant service 250, 260, 270 or may rely on an express invocation by the user through the use of special command characters or command inputs provided to the generative interface.

In some implementations, one or more of the assistant services 250, 260, 270 may be configured to match or mimic the behavior and expertise of a system user. For example, the system 200 may include an assistant generation interface, which may be incorporated into the generative interface, described in example user interfaces, herein. The assistant generation interface may, in response to a user request, initiate the creation of a new assistant service. The user request may include a designation of a corpus of electronic resources including, for example, knowledge base articles, documentation pages, or other electronic document that represents a user's subject-matter expertise. The interface may also provide a prompt to request a link to the corpus of electronic resources or may designate a network location to which the resources are provided. The system may also be configured to generate or adapt a custom configuration module for the user-based assistant service, which may be generated based on user interaction logs, event history logs, or other data generated during previous interactions with one or more platforms and that may be representative of the user's characteristics with respect to the one or more platforms. Additionally, one or more plugins may be selected based on a prediction regarding a specialized set of functions that the user-based assistant service may be configured to perform. The user may also designate, through the interface, a response style, tone, or other characteristics that are desired in the user-based assistant service. In response, the configuration module may be adapted to include predefined prompt text and other content that facilitates the user's requests or preferences for the user-based assistant service. Additionally, a user profile including a profile picture and/or avatar may be generated and associated with the user-based assistant service for use with the various user interfaces and other system components.

As shown in FIG. 2, the prompt management service 220 also has access to user profiles 222, which may be managed by each of the respective platform backend applications 203, 205, 207. The user profiles 222 may include role data, user classifiers, permissions data, prior user history, and other data associated with a registered or active user account on a respective platform. The user profiles 222 may be used to improve intent recognition operations and a user role or user classifier may be used as an input to an intent recognition model. This allows for tailoring of different types of operations for different classes of users or based on prior user activity. The user profile 222 may also be used to determine which content is available for analysis and display while maintaining existing permissions and security procedures and controls.

The user profiles 222 may also include permissions profiles, user roles, and other user-access data that can be used to authorize a particular user to view, edit, or otherwise manage content items of a respective platform. For example, a user may be required to have a particular role and set of access permissions before viewing or editing certain content items managed by a particular platform. Each platform may have an authentication module and permissions management service that ensures that authenticated users have the permissions that are consistent with a permission profile or permissions criteria associated with a respective content item. In this example, the prompt management service 220 may be adapted to leverage the permissions profile of a current authenticated user (using the generative interface panel or otherwise invoking generative services) in order to access content on behalf of the user. The prompt management service 220 may, for example, leverage user credentials, an authentication token, or other authentication data to access content items using a permissions scheme dictated by the respective platform providing the content. Further, the prompt management service 220 may enable the various assistant services 250, 260, 270 to also leverage the authentication data to obtain access to content items of the various backend applications 203, 205, 207 (also referred to as “platforms”). This enables the system 200 to leverage existing permissions protocols and schemes to access content items while also ensuring that an authenticated user is exposed to content that would not be ordinarily available to that user. In some cases, portions of the persistence module 224 and other aspects of the system that may store portions of content items or recognize the existence of certain content items may be cleared at the end of every session to prevent inadvertent exposure across users. Additionally or alternatively, the persistence module 224 and other aspects of the system may define user-specific caches or memory storage to help prevent inadvertent disclosure of potentially sensitive content.

As mentioned previously, the prompt management service 220 also has access to or includes a persistence module 224, which may include a cache or other storage of previous user inputs, generative outputs, or other interactions with the content discovery and generation interface 210. The persistence module 224 may store previous exchanges with the content discovery and generation interface 210 using a session identifier and a hierarchically related set of content nodes. Each node may include content or reference to content either input directly to the generation interface 210 or generated in response to a user input. In some cases, the nodes could include results produced by one or more of the plugins or assistant services that have been stored but not displayed. This allows the prompt management service 220 to reference previous exchanges with the current platform or a separate platform in order to construct more complete or accurate prompts that are provided to the generative output engine 230. For example, a user input having a particular grammatical form or lacking an object, may trigger the prompt management service to parse previous content nodes or exchanges in a common session in order to identify an object or complete the query. For example, a first user input may state, “find all of the issues and pages that are related to project Apollo.” The result may include content extracted from, links to or other reference to a set of results. A portion of the results or a reference to the results may be stored in a node of the persistence module 224 and associated with a session ID of the current session. A subsequent user input may state, “which ones were created in the last week?” In order, to generate a response to the second input, the prompt management service 220 may detect the grammatical reference to “ones” or may detect the lack of a specific object and, in response, may query the persistence module 224 for one or more nodes that are associated with the current session ID. Content extracted from those nodes or referenced by those nodes may be used to generate a new prompt and/or refine the previous results in order to generate a response to the second user input. The persistence module 224 may also allow the prompt management service 220 to bridge exchanges that occur with respect to multiple platforms or frontend applications 202, 204, 206 to provide cross-platform support. In some cases, a session ID is generated for each concurrent or overlapping exchange with a particular frontend application 202, 204, 206 and the respective session IDs may be associated with each other and/or the overlapping sessions may be assigned a session ID, which may be utilized by the persistence module 224 to link conversations and exchanges between multiple frontend applications 202, 204, 206.

Similar to the other examples described herein, the prompt management service 220 is used to create text-based prompts that are transmitted to a generative output engine 230, which may include a LLM or other generative service. The generative output engine 230 may either be integrated with internal services or may be an external service that is accessed using application programming interface calls, similar to other examples described herein. The generative response created by the generative output engine 230 may be used by the prompt management service 220 to provide the response that is displayed or rendered in the content discovery and generation interface 210 and/or with the graphical user interface provided by one of the respective frontend applications 202, 204, 206. In some instances, the generative output engine 230 may be one of a variety of generative output engines or models that are associated with the system 200. In some implementations, a different model may be associated with different assistant services and may be selected or adapted for use with a particular subject-matter expertise of a respective assistant service. For example, a model having a corpus or set of tokens that are tailored for a particular subject matter or type of inquiry may be selected from a set of models in order to provide generative content for a respective assistant service tailored for a similar subject matter or type of inquiry. For example, a dedicated or specialized code base model (e.g., a code base LLM) may be selected for use by an assistant service that is configured to provide code snippets or assistance with code generation or debugging. Another type of model having a different corpus of tokens may be adapted for a different task, like project definition or project specification and may be selected for use with an assistant service tailored to provide project definition or specification assistance.

Example implementations of an automated chat interface invoking automated assistant services described herein are depicted in FIGS. 3A-3C. FIGS. 3A-3C each depict example frontend interfaces that can interact with a system as described herein to receive prompts from a user that can be provided as input to a generative output engine as described herein.

In particular, FIG. 3A may represent a user interface of a documentation platform rendering a frame to receive user input from a user by leveraging a centralized editor service. The user interface 300a can be rendered by a client device 302 which may be a personal electronic device such as a laptop, desktop computer, tablet and the like. The client device 302 can include a display with an active display area 304 in which a user interface can be rendered. The user interface can be rendered by operation of an instance of a frontend application associated with a backend application that collectively defines a software platform as described herein.

More particularly, as described above in reference to FIG. 1, a platform can be defined by communicably intercoupling one or more frontend instances with one or more backend instances. The backend instance of software can be instantiated over server hardware such as a processor, memory, storage, and network communications. The frontend application can be instantiated over physical hardware of a client device in network communication with the backend application instance. The frontend application can be a native application, a browser application, or other application type instantiated over hardware directly or indirectly, such as within an operating system environment.

FIG. 3A depicts the active display area rendering a graphical user interface 300a associated with a frontend of an example documentation system or platform. The documentation platform can communicably couple to a centralized content editing frame service to render an editor region 306a that can receive user input. The user input may be text, media, graphics, or the like. The user input may be used to receive user-generated content that may be stored as electronic pages or electronic documents, also referred to herein as simply “pages” or “documents.” The graphical user interface 300a may be operated in a content view mode or a content edit mode. Content edit permissions are only permitted for documents or pages having a permissions profile that allows read and write access for a respective authenticated user. Documents or pages may be accessed in a content view mode in response to the permissions profile allowing at least read access for the respective authenticated user. The graphical user interface 300a may also include a navigational panel 305, which may include various selectable elements that are selectable to cause display of respective content items in the editor region 306a.

In some cases, the user input may be provided when the frontend is operated in a command receptive mode. A generative service can be triggered or invoked in response to a user input, which may include a user selection of a control or affordance of the graphical user interface 300a. The generative service can also be invoked in response to a user typing a special character (e.g., a slash) in an editor of the graphical user interface 300a. Specifically, the user may type a special character in the editor region 306a in line or along with user generated content 308. The user may type into the editor region 306a a partial input 308a or selection of a control that causes instantiation of the generative service and/or triggers rendering of interface 310, which may be used to receive natural language user input and render generative output. Upon receiving and recognizing the invocation of the generative service, the frontend and/or the backend may cause to be rendered an interface 310 that can be used to receive natural language input in an input region 312 and provide generative output in a response region 316. In the present example, the interface 310 is a generative interface panel that overlays or overlaps content of the graphical user interface 300a. In some implementations, the interface 310 is rendered as a distinct panel that does not overlay or overlap existing content but may, instead, cause the automatic reduction of a content panel or other element of the graphical user interface 300a. Also, in the present example, the interface 310 is rendered as a chat or series of messages that may be chronologically ordered starting with an entry 314 corresponding to the initial user input, responses 316, 318 and other subsequent exchanges. As described herein, the series of messages may be stored as nodes in a persistence module, associated with a session ID, and recalled by the current platform or another platform in order to provide more complete or accurate generative responses.

The input region 312 may be configured to receive natural language text input which may be analyzed to associate the input with a specific command or action. For example, the natural language input may be analyzed to determine commands including: summarize, provide a list of action items, define the problem statement, create new content based on an existing content item, and other commands described herein. In some implementations, the user input is a hybrid of natural language text and selectable options or controls. For example, the interface may include a graphical element 313 that includes one or more selectable options that appear in response to a partial text input, each selectable option corresponding to a command or class of commands that may be provided in the user input. In some cases, the user input is provided solely through the use of selectable controls and does not include human-entered natural language. Further, in some examples, selectable controls and/or auto-complete are used to generate all or a portion of the natural language user input.

In this example, the interface 310 includes multiple automated assistant services, indicated by avatars or indicia 305, 307. A first automated assistant service represented by indicia 305 may correspond to a documentation assistant service having a subject-matter expertise or function set directed to the analysis and modification of electronic documents managed by a documentation platform. The second automated assistant represented by indicia 307 may correspond to an issue tracking assistant service having a subject-matter expertise function set directed to the analysis and modification of issues or tickets managed by an issue tracking platform.

In this example, the user input includes a request regarding the status of various issues or tasks that may be described with respect to a current page or document. In response to an intent analysis of the natural language user input, the generative service may determine that the natural language input is directed to a compound inquiry or otherwise requires the use of multiple assistant services. As a result, the generative service may first invoke the first assistant service, which may be used to obtain a list of tasks or issues within the content of the page. The first assistant service may, for example, extract portions of the current page being displayed in editor region 306a and generate a prompt that is transmitted or provided to a generative output engine to obtain a series of tasks. The assistant service may use an issue mapping plugin to identify issue objects that correspond to tasks returned by the generative output engine. The result may be displayed as response 316, which includes an avatar or indicia of the first assistant service. The generative service operating the interface 310 may then invoke or call the second assistant service to obtain a current status of each respective issue identified by the first assistant service. The current status may correspond to a present state of an issue or ticket that is being processed in accordance with a given workflow or programmed set of states by an issue tracking platform. The result is displayed in a subsequent response 318, which includes an avatar or indicia of the second assistant service. The response 318 may also include selectable controls 319, which may enable further functionality or operations with respect to the result. Additionally or alternatively, each of the items displayed in the response 318 may be selectable to cause redirection to a respective issue within the issue tracking platform.

FIG. 3B depicts another graphical user interface 300b of a documentation system or platform. Similar to the previous example, a frontend application, a documentation system, is operating on a client device 302 and is used to display a graphical user interface 300b in an active display area 304. Also similar to the previous example, the graphical user interface 300b includes an interface 320 that is operated by a generative service which includes multiple assistant services, which may be used to respond to a user input. In this example, the natural language user input is received at the input region 322. In this example, the natural language user input references a project “Apollo,” and requests that the system generate a summary of that project. In response to the user input, the system analyzes the natural language input to determine an action intent using a natural language processing tools and an intent recognition module, as described above with respect to FIG. 2. In this case, the system determines that the action intent indicates a request for information from a separate project and user directory and, as a result, selects the second assistant service, which uses a project inquiry plugin to provide the requested operation. Using the project inquiry plugin of the second assistant service, the system executes a query on the separate platform to extract content from content items associated with the search term “Apollo.” Using the extracted content, the system generates a prompt, which is transmitted to a generative output engine, which returns a generative response. At least a portion of the generative response is displayed in the response region 326 of the interface 320. In this example, additional actions or controls may be rendered in the output 326. Specifically, the response includes an insertion control 330, which may be selected to cause display of further prompts or selections for directing the generative content into a content item of the system. The response also includes an action control 332, which may be selected to cause display of further prompts or selections for causing further analysis or generative output based on the existing result or output. In some cases, the action control 332 may include a request to explain or demonstrate the source of the results or generative output. For example, selection of the action control 332 may cause the system to identify plugins or operations performed, materials used to generate the result, or other intermediate steps or operations used to arrive at the result or generative output. In some cases, the system may generate a log of actions and content used in servicing a user input, which may be referenced and displayed, in part, based on a user selection of a respective action control 332.

Similarly, FIG. 3C depicts a graphical user interface 300c of an issue tracking system. As with the embodiment shown in FIG. 3A, the issue tracking system of FIG. 3C includes a graphical user interface 300c rendered by a client device 302 on a display thereof. The display leverages an active display area 304 to render an editor region 306c that is configured to receive user input to describe a particular issue tracked by the issue tracking system. In this example, as with the preceding example, the user may type into the editor region 306c a partial input 308c or selection of a control that causes instantiation of the generative service and/or triggers rendering of interface 340, which may be used to receive natural language user input and render generative output. In this example, the user may provide a natural language input that is determined to correspond to an issue analysis plugin or similar service. Specifically, the user input includes a request for a summary of an issue or project by stating “get up to speed.” In response, the generative service may select the second assistant service, which uses a respective plugin to obtain an issue description, comments on the issue, and issue state transitions. This extracted information along with other context data of the session may be used to produce response 346 in the interface 340. In this example, additional actions or controls may be rendered in the output 346. Specifically, the response includes an insertion control 350, which may be selected to cause display of further prompts or selections for directing the generative content into a content item of the system. The response also includes an action control 360, which may be selected to cause display of further prompts or selections for causing further analysis or generative output based on the existing result or output.

While some of the examples provided herein are directed to a chat-based interface in which a user provides an input to an input region and responses are provided within the chat interface, other implementations or actions may extend from these examples. For example, one or more of the automated assistants may be invoked from outside of the context of the chat interface and, in some cases, the generative response or resulting action occurs outside of the chat interface. For example, an assistant service may be invoked from within an editor to provide some or all of the functions described herein. Further, the output of the assistant service may include the automatic creation of comments, mentions, edits and other content, which may be directly inserted into the content of the respective platform.

These foregoing embodiments depicted in FIGS. 3A-3C and the various alternatives thereof and variations thereto are presented, generally, for purposes of explanation, and to facilitate an understanding of various configurations and constructions of a system and related user interfaces and methods of interacting with those interfaces, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein.

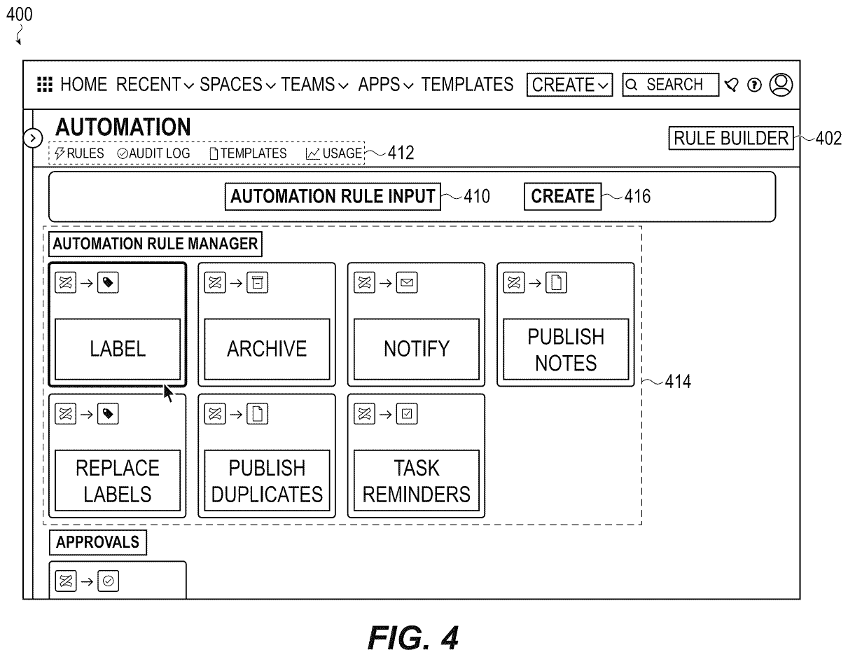

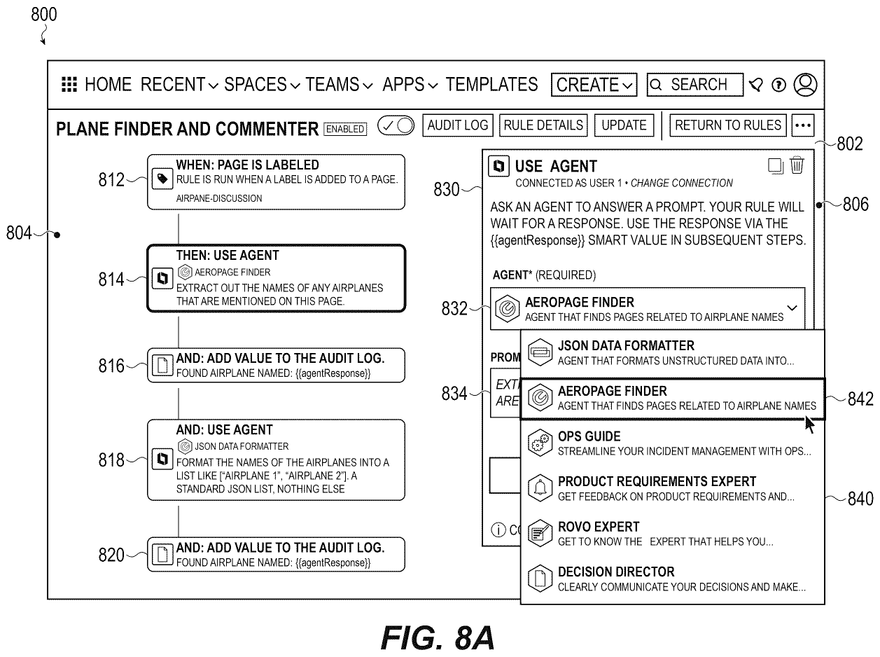

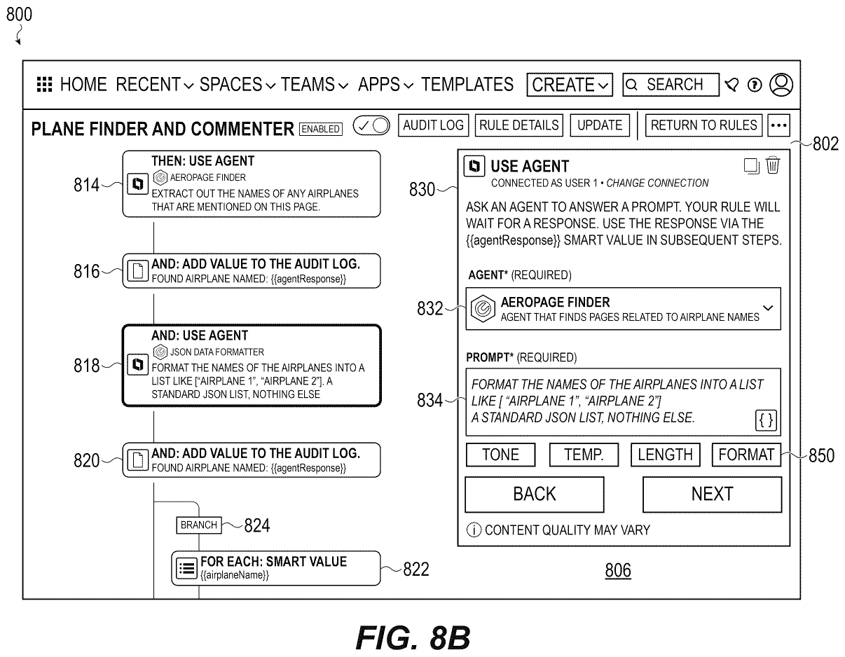

While FIGS. 3A-3C describe example implementations in which one or more automated assistant services may be invoked from a generative interface. As also described herein, one or more of the same automated assistant services may also be invoked from an automation service executing an automation rule. Specifically, an automation rule may define an automation component that invokes or references an automated assistant service, which may allow the automation rule to leverage functionality of one or more automated assistant services that are defined for use with an automated chat service or generative interface. FIGS. 4-7, described below, are generally directed to interfaces of the system that can be used to generate an automation rule including an automation trigger and a set of automation components. FIGS. 8A-13 are more specifically directed to the use of automated assistant services within the automation service and the definition of automated assistant service-related automation components.

FIG. 4 depicts an example frontend interface 400 that supports automation rule creation and automated content assessment for collaboration platforms, in accordance with aspects described herein. Frontend interface 400 may also be referred to as a UI or GUI. The frontend interface 400 can be rendered by a client device 104 or a client device 106, which may be a personal electronic device such as a laptop, desktop computer, tablet, and the like. The client device can include a display with an active display area in which a user interface, e.g., frontend interface 400 can be rendered. The user interface can be rendered by operation of an instance of a frontend application associated with a backend application that collectively defines a software platform as described herein.

More particularly, as described with reference to system 100, a platform can be defined by communicably intercoupling one or more frontend instances with one or more backend instances. The backend instance of software can be instantiated over server hardware such as a processor, memory, storage, and network communications. The frontend application can be instantiated over physical hardware of a client device in network communication with the backend application instance. The frontend application can be a native application, a browser application, or other application type instantiated over hardware directly or indirectly, such as within an operating system environment.

As shown, frontend interface 400 includes rule builder button 402, a text input field 410, selectable tabs 412, a display area 414, and a create button 416. Text input field 410 is a field configured to accept textual inputs, for example a natural language rule for the creation of automation rules. The create button 416 can be used to submit the textual input in the text input field 410 for creation of an automation rule by the system 100, for example using or aided by a generative output service.

In one or more embodiments, selectable tabs 412 include tabs for “rules,” “an audit log,” “templates,” and “usage,” each of which may cause a different display to appear in display area 414. Selecting the rules field causes the display area 414 to display automation rules for management. The information for the displayed rule can include at least a name, description scope (e.g., on what projects, or types of projects, the rule will run), an indication of whether to allow the rule to run from another rule, an error notification status, an owner of the rule, a rule actor (e.g., the party indicated as responsible when the rule is executed), and permissions for the rule (e.g., persons or groups allowed to modify the rule). As an example of automation rules, an automation rule manager may display a list, icon, or other indicator of automation rules created by a user in display area 414. Examples of such automation rules (e.g., created or for a template, as further discussed herein) include a “label” rule (e.g., adding a specific label when a page is published by a certain author), an “archive” rule (e.g., archiving inactive pages when scheduled (recurring)), a “notify” rule (e.g., notify certain people about inactive pages when scheduled (recurring)), a “publish notes” rule (e.g., publish new meeting notes page when scheduled (recurring)), a “replace labels” rule (e.g., replace a label on all pages when scheduled (recurring)), a “publish duplicates” rule (e.g., publish the same set of pages when a new space is created), and a “task reminders” rule (e.g., remind teammates about incomplete tasks when scheduled (recurring)). In some embodiments, these example rules may support automation rules within a documentation platform. In other embodiments such rules, or other rules, can be for other platforms or a combination of platforms within a system including collaboration platforms.

In one or more embodiments, selecting the templates tab may cause a display to appear in display area 414 that includes templates that a user may utilize to create automation rules from a template. Such templates provide predefined structure for common automation rules that a user may want to use in the manual creation of an automation rule.

In one or more embodiments, selecting the audit log tab may cause a display to appear in display area 414 that includes an audit log for the automation rules. In one or more embodiments, each automation rule may include an audit log that identifies when the automation rule was triggered, the final result of the execution of the automation rule, and any action performed as a result of the automation rule execution. In some embodiments, the audit log may indicate a duration of the execution and the status (e.g., success, error, and so on) of the execution.

In one or more embodiments, selecting the usage tab may cause a display to appear in display area 414 that includes usage information for the automation rules. The usage information includes an outline of your automation usage (e.g., for a particular time frame). For example, each automation rule may be identified, together with a quantity of runs/executions of the automation rule, an “owner” or other responsible person for the rule, a scope of the rule (e.g., which collaboration systems are associated with the rule), and an activation status for the automation rule (e.g., whether execution of the rule is turned “on” or “off”).

According to one or more embodiments, previously-created automation rules, including automation rules generated from using a generative output engine, as further described herein, can be stored at the system 100. In some examples, rules may be stored in a database 118 for retrieval and use by a component of the set of host servers 102, such as the centralized automation rule service 112, the first platform backend 108, or the second platform backend 110. In some examples, the rules may be stored in the resource allocation of a portion of the host servers 102, such as the resource allocation of the platform from which the automation rule is to be executed, for example resource allocations 108a of the first platform backend 108, or resource allocations 110a of the second platform backend 110.

In one or more embodiments, the rule builder button 402 may be selected by a user to direct the frontend interface 400 to a rule builder that can be leveraged by a user to generate automation rules from components with assistance from graphical elements, as further described herein.

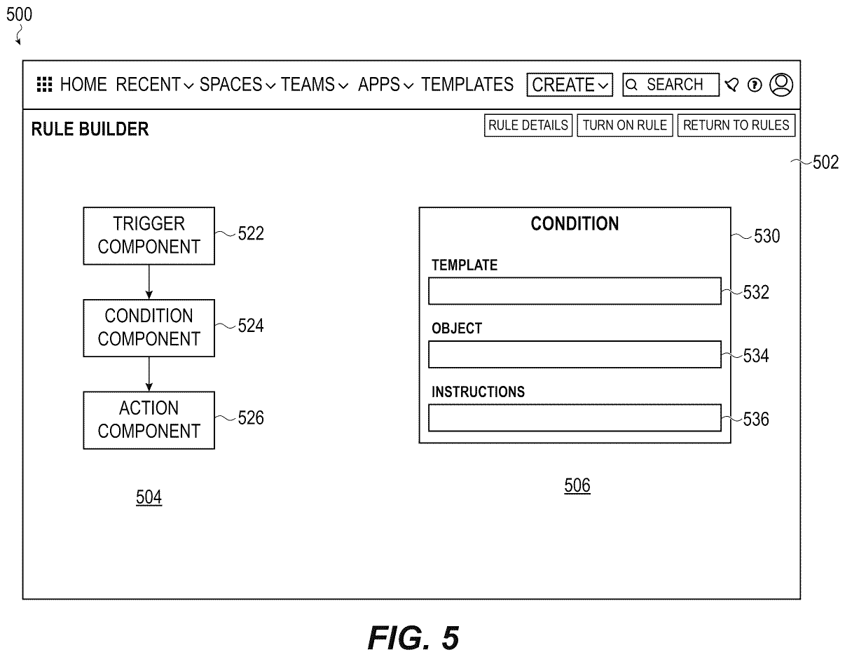

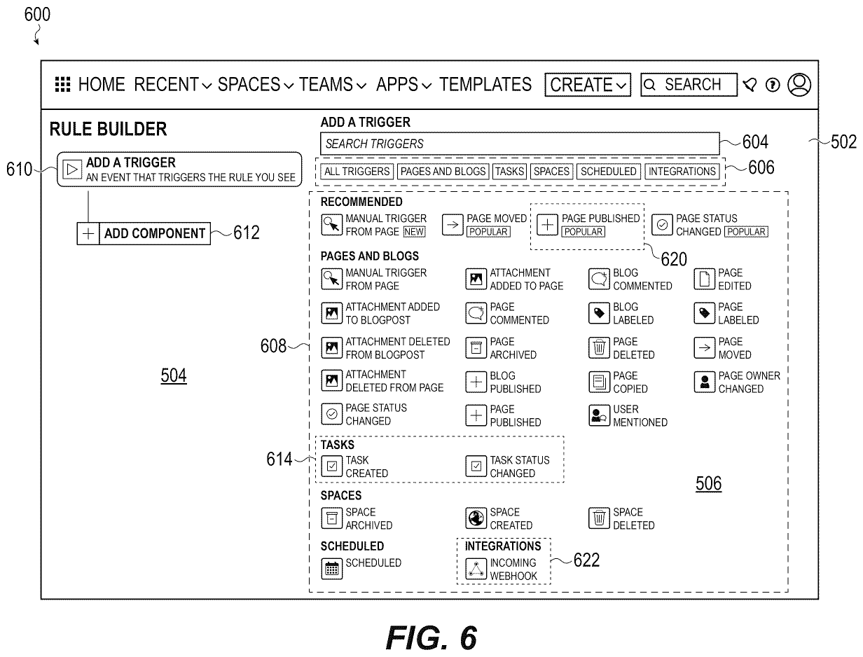

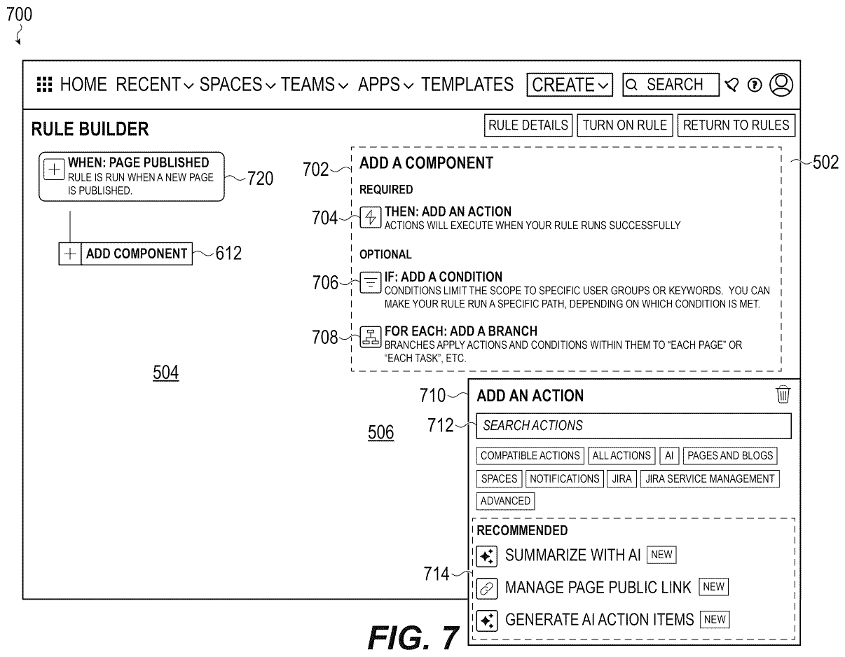

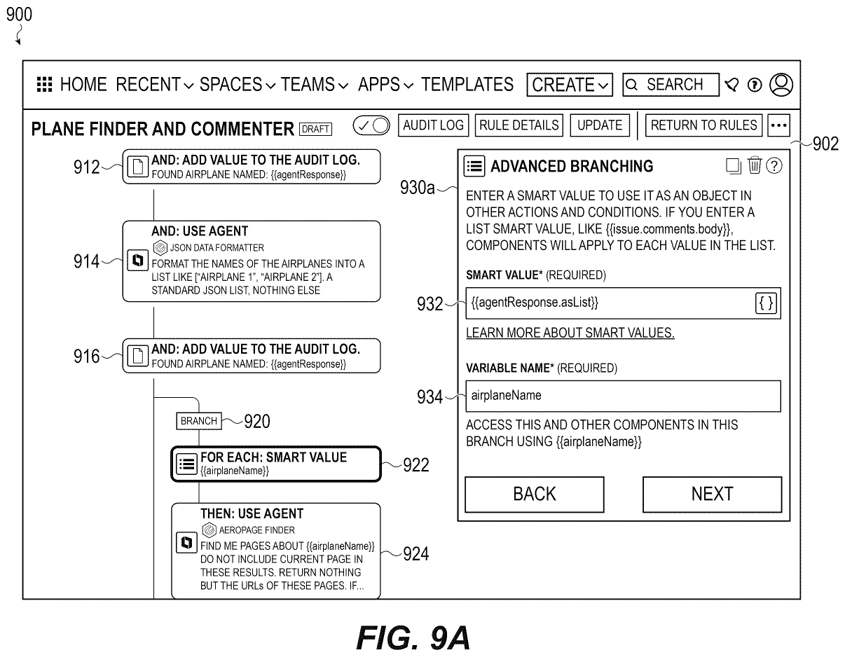

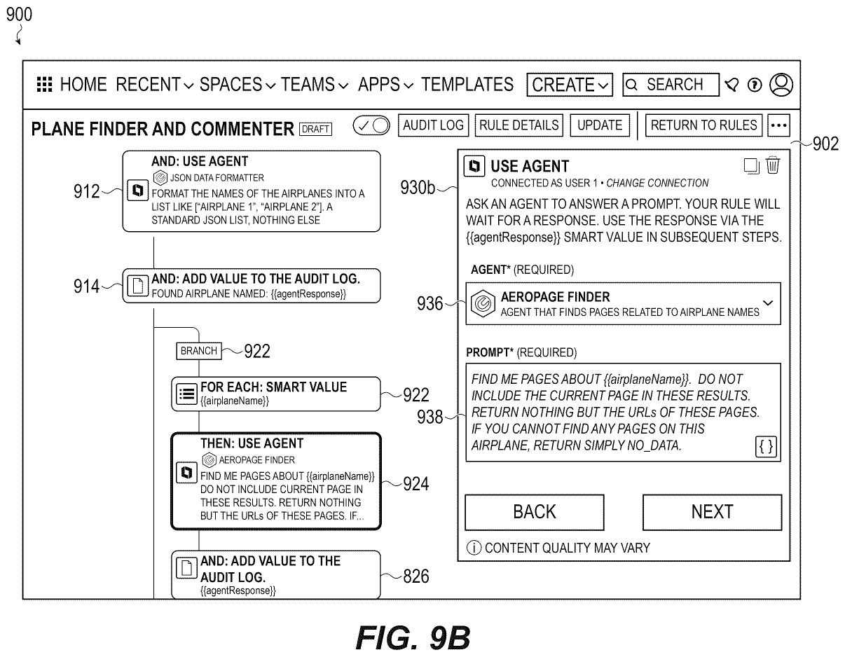

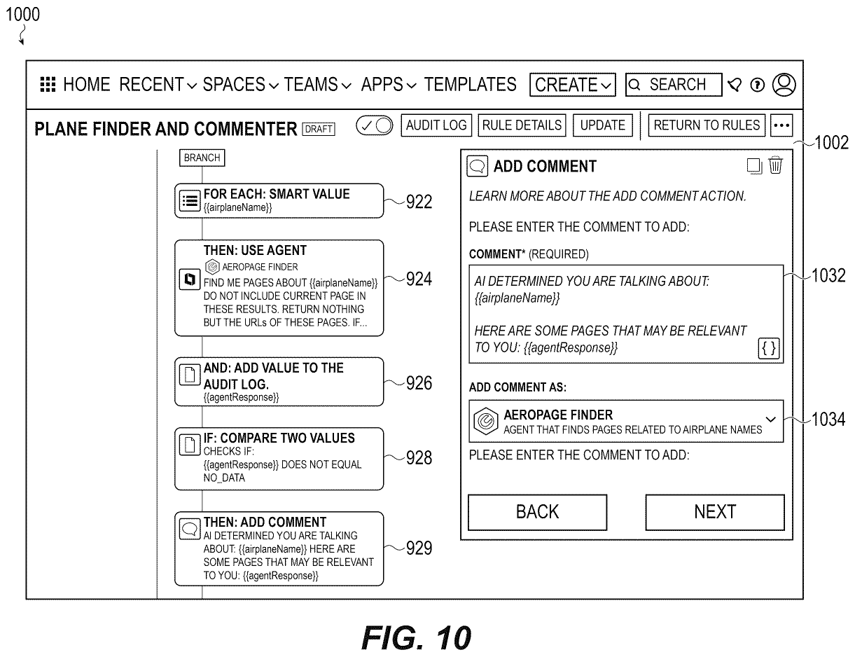

FIGS. 5-10 generally depict frontend interfaces in an example of a flow to generate an automation rule. FIG. 5 generally depicts an interface that is used to generate an automation rule that includes conditions utilizing a generative output engine. FIG. 6 generally depicts an interface the selection of a trigger component for an automation rule flow. FIG. 7 generally depicts required and optional component categories for a user to select to display additional automation rule components to add to the automation rule flow, incorporating the previously-selected trigger component. FIG. 6 generally depicts an example of the trigger component being an incoming webhook. FIG. 7 generally depicts the selection of a condition component for an automation rule flow, incorporating a previously-selected trigger component, including a condition component that utilizes the generative output engine. FIG. 8 generally depicts the selection of specifics of a condition component that utilizes the generative output engine. FIG. 9 generally depicts the selection of an action component for an automation rule flow, incorporating the previously-selected trigger component, including one or more action components that utilize the generative output engine. FIG. 10 generally depicts the selection of specifics of an action component that utilizes the generative output engine.

FIG. 5 depicts an example frontend interface 500 that supports automation rule creation and automated content assessment for collaboration platforms, in accordance with aspects described herein. Frontend interface 500 may also be referred to as an automation generation user interface or simply as a UI or GUI. In one or more embodiments, frontend interface 500 may be displayed at a same display or interface as frontend interface 400, for example rendered in response to a user selecting the rule builder button 402. The frontend interface, in this example, includes two main regions, the control region 506 for defining automation components and a proposed automation flow (or workflow) region 504 displaying the current state of the automation rule being defined or edited. The proposed automation flow region 504 of the frontend interface 500 displays the rule builder 502, which includes graphical elements to assist a user in generating an automation rule to operate in a collaboration system (e.g., system 100), as further described herein. In some embodiments, rule builder 502 may be at least a part of a GUI that is rendered by one of first platform backend 108 or second platform backend 110. In this example, the proposed automation flow region 504 includes graphical elements representing automation rule components. In some examples, the graphical elements representing automation rule components may be replaced during rule building with graphical elements representing selected automation rule components. For example, the proposed automation flow region may include a trigger adding button that may be replaced by a graphical element representing a trigger component 522 that is selected. The trigger adding button may also generally be a component adding button. The proposed automation flow region may further include a condition adding button for a condition component 524, which may also generally be a component adding button. The proposed automation flow region may further include an action component 526, which may also generally be a component adding button.

As shown in the frontend interface 500, the condition component may be modified in the control region 506 via a condition window 530 used to set, modify, or otherwise define characteristics of the condition component 524. Generally, the condition window 530 may be used to select an object via an object input field 534 to which the condition refers, and provide instructions via an instruction input field 536 for determining whether the condition is satisfied.

In some examples, the object input field 534 may refer back to the object referenced by the trigger component 522. That is, the same object whose state change triggered the automation may be the same object or portion of the object for object input field 534. For example, a page creation or modification may trigger the automation rule according to trigger component 522, and the object input field 534 may be the page or another content portion of the page, such as a page title or body. In another example, the object or portion of the object for object input field 534 may be different than an object for the trigger. For example, the object input field 534 may be a page (or other object), and the trigger for the trigger component 522 may be a manual trigger, a timer, a status change for a page, a publication or movement of the page, a creation of a task in an issue tracking system, an access or modification of source code in a source code management platform, or other object.

The instruction input field 536 may generally refer to parameters that may be used by the generative output engine to determine whether the condition of condition component 524 is satisfied. For example, instruction input field 536 may be an indication of text, such as a string, that is compared against object input field 534 by the generative output engine. For example, the object input field 534 may be a content portion of a page header in a documentation system. The instruction input field 536 may be text, such as a specific project name, “marketing,” “sales,” “team retreat,” “code review,” “positive, cheery sentiment,” or any other subject, topic, or category, that is used by the generative output engine compared against the content portion of the page header to determine whether the condition is met or satisfied. Such indication may be generally referred to herein as a classifier, and may have an associated string (a classifier string).

It should be noted that the comparison performed by the generative output engine is generally not a text or word search within the object. That is, a prompt is generated for the generative output engine that includes a content portion from the object input field 534, an indication of the instruction input field 536 (e.g., one or more classifier strings), and a set of example input-output content to classifier pairs. The input-output content to classifier pairs may be examples of “correct” mappings of content (e.g., content portions) to classifier strings that are used for learning by (e.g., used to teach) the generative output engine. For example, the classifier may be related to a tone of the object, such as “positive and optimistic,” in which case the pairs may include a set of text blocks that the generative output engine (via the prompt) is informed are considered to be “positive and optimistic.” The generated prompt may be specific to the instructions selected via the instruction input field 536, the object input field 534, or both. That is, a prompt generated for a first classifier may have one set of example input-output content to classifier pairs, but a prompt generated for a different classifier may have a different set of example input-output content to classifier pairs. For example, for a “code review” classifier the set of pairs for the generated prompt is generally different from the set of pairs where the classifier is “upbeat tone.”

In some embodiments, the condition window 530 may further include a template input field 532 that can be used to specify a template for the condition window 530. That is, the object input field 534 and the instruction input field 536 may operate differently or present different information depending on input received at the template input field 532. For example, template input field 532 may be a pre-populated dropdown list, and the selection of a template from the list may be used to populate a dropdown of candidate objects for the object input field 534. For example, a template of the template input field 532 may be “page.” Selection of the “page” template may result in two selectable objects in the object input field 534: a first selection corresponding to a content body of a page, and a second selection corresponding to a title of the page.

As used herein, an input field may generally be populated via a text entry, or be populated via a dropdown selection. In some cases, text may be suggested (e.g., auto-populated) as a user type. The suggestion may be context-specific. For example, the suggested text may be different for an AI condition (e.g., condition using a generative output engine) than for a Confluence Querying Language (CQL) condition. Similarly, the suggested text may be component-type specific, for example different for a condition component than an action component.

In one or more embodiments, the object that triggered the trigger component 522 may be of a first platform (e.g., the first platform backend 108), and the object referenced by the condition component 524 may be of a second platform (e.g., the second platform backend 110). That is, the object referenced by the object input field 534 may be of a different platform than the object that triggered the automation rule. For example, a trigger may be satisfied by a change of status of a ticket in an issue tracking system, and the condition may be satisfied by the existence of a document within a documentation platform that relates to a positive product review as a classifier. In another example, a non-platform object may trigger the automation rule, and the object of the condition may be of one of the platforms (e.g., the first platform backend 108 or the second platform backend 110). Alternatively, in other embodiments, the object that triggered the automation rule may be of one of the platforms, while the object of the condition may be a non-platform object.

In some embodiments, the object referenced by the condition component 524 may be of a first platform (e.g., the first platform backend 108), and an object acted on according to the action component 526 may be of a second platform (e.g., the second platform backend 110). That is, the object referenced by the object input field 534 may be of a different platform than the object acted on or created as a result of the condition being met. For example, the condition may be met by a page of a documentation platform being created whose body or title relates to financial budgeting at a classifier. The object acted upon by the action component 526 may be the creation or modification of a ticket within an issue tracking system. In another example, a non-platform condition may be satisfied according to the automation rule, and the object of the action performed as a result of the condition being satisfied may be a non-platform object. Alternatively, in other embodiments, the object evaluated for the condition may be a non-platform object, while the object of the condition may be of one of the platforms (e.g., the first platform backend 108 or the second platform backend 110).

In some embodiments, user permissions may be evaluated when an automation rule operates across platforms, or between one of the platforms and a non-platform system. That is, as part of running an automation rule that starts, is initiated, or otherwise triggered in a first platform, one or more conditions or actions may use a second platform as described herein. In such case, the process of performing the automation may further include verifying or checking the credentials (permissions) of a user with the second platform. In other embodiments, access may be granted or denied based on a user role. Where an automation rule has been created (e.g., established as a service), if the user does not have sufficient permissions to access an object of the second platform, then the automation rule may cease to run or fail. In one or more embodiments, an error message or other indicator may be provided to the user or logged to indicate the failure to run the automation rule by reason of a lack of permissions. In some embodiments, where one or more components of the automation rule require checking permissions to access an object of a platform (e.g., the second platform or a non-platform system referenced by the automation rule), a GUI may be displayed to a user for the user to enter the user's credentials associated with that platform. The entered credentials may then be provided to the platform to allow the automation rule to continue to run.

In one example, an action (e.g., an action using the generative output engine), may be used to update a parent page in a hierarchy of pages. For example, if a user creates a page in a particular group of pages, a summary or other parent page may be created or updated with information from the newly created child page. For example, the parent page may include a summary and/or action items generated by the content generation engine. Upon creation of a new child page (e.g., in a designated group or set of pages), the content generation engine may be used to update the parent summary and/or the action items. A prompt may be generated with instructions and/or a template, the old parent page, the new child page, and sample input-outputs, and a new parent page returned by the generative output engine. Alternatively, the prompt may be generated with instructions and/or a template, the old child page, the new child page, and sample input-outputs, and a new parent page returned by the generative output engine that can replace the old parent page.

FIG. 6 depicts an example frontend interface 600 that supports automation rule creation and automated content assessment for collaboration platforms, in accordance with aspects described herein. Frontend interface 600 may also be referred to as a UI or GUI. In one or more embodiments, frontend interface 600 may be displayed at a same display or interface as frontend interface 400 or frontend interface 500, for example rendered in response to a user selecting the rule builder button 402. The frontend interface 600 includes the rule builder 502, which includes graphical elements to assist a user in generating an automation rule to operate in a collaboration system (e.g., system 100), as further described herein. In some embodiments, rule builder 502 may be at least a part of a GUI that is rendered by one of first platform backend 108 or second platform backend 110.

Similar to the previous example, rule builder 502 may include a proposed automation flow (or workflow) region and a control region 504 and a control region 506. Generally, the proposed automation flow region 504 includes graphical elements representing automation rule components. In some examples, the graphical elements representing automation rule components may be replaced during rule building with graphical elements representing selected automation rule components. For example, the proposed automation flow region may include a trigger adding button 610 that may be replaced by a graphical element representing a selected trigger component, and a component adding button 612 that may be replaced by a selected action component. The proposed automation flow region may expand or contract as automation rule components (and their respective graphical elements) are added or deleted.

Generally, the control region 506 may include a search box for automation rule components, tabs for categories of those automation rule components, and graphical elements representing selectable automation rule components.

In one or more embodiments, the rule builder 502 of the frontend interface 600 may include a search box 604, a set of tabs 606, and a set of trigger components 608 in the control region, and a trigger adding button 610 and a component adding button 612 in the automation workflow region. Frontend interface 600 illustrates a simplified view. In some embodiments, rule builder 502 may be embedded within another GUI (e.g., window), or include one or more additional textual and/or graphical elements not shown with reference to frontend interface 600.

The search box 604, the set of tabs 606, and the set of trigger components 608 may be rendered and displayed to a user, for example responsive to the user initiating (starting, entering) the rule builder 502 and selecting the graphical element that is the trigger adding button 610. In some embodiments, after selecting a trigger component for an automation rule, a user may select the graphical element that is the add a component, button 612. In other embodiments, a user may select the graphical element that is the add a button 612 before selecting the trigger component.

The set of trigger components 608 includes trigger components that may be used to initiate an automation rule based on an event. In some embodiments, the triggers may be organized into one or more groups or subsets of triggers components. In the example of the frontend interface 600, the groups include recommended, pages and blogs, tasks, spaces, scheduled, and integrations. In this example, the recommended triggers include a manual trigger from a page, a page moved, a page published, or a page status changed, for example page published trigger 620. The pages and blogs triggers include a manual trigger from a page, an attachment added to a blogpost, an attachment added to a page, an attachment deleted from a blogpost, an attachment deleted from a page, a blog commented, a blog labeled, a blog published, a page archived, a page comments, a page copied, a page deleted, a page edited, a page labeled, a page moved, a page owner changed, a page published, a page status changed, or a user mentioned. The tasks triggers include task created and task status changed. The spaces triggers include space archived, space created, or space deleted. The scheduled triggers include a scheduled trigger. The integrations triggers include an incoming webhook trigger, for example incoming webhook trigger 622.

In one or more embodiments, the recommended triggers of the set of trigger components 608 may be based on a usage history for the user, such as the quantity of uses for the trigger component exceeding a threshold value or the user's most used trigger components (e.g., ten most used trigger components). In other embodiments, the recommended triggers are based on the quantity of uses by a group of users (e.g., of the platform, or accessing a centralized automation rule service 112), and may include the most used trigger components or the trigger components whose usage has exceeded a threshold value. In some cases, the recommended triggers may be a curated list within a platform or the centralized automation rule service 112, and may depend on which platform a user is accessing. In some embodiments, the generative output service 116 may be trained on the usage of trigger components for automation rules within a platform or set of platforms, and be used to determine the recommended trigger components based on one or more inputs and a list of potential or candidate trigger components. In some examples, the generative output service 116 can receive (e.g., from the centralized automation rule service 112) information regarding a history of trigger component selections (e.g., for a particular user, group of users, particular platform, or by other groupings), and this information used by the generative output service 116 to provide (e.g., from the centralized automation rule service 112) an indication (e.g., suggestion or recommendation) for a trigger component or set of trigger components 608 (e.g., as the “recommended” trigger components) as part of automation rule building and creation.

The trigger groups for the set of trigger components 608 may be selectable via the set of tabs 606. For example, by selecting the “tasks” selectable element, the set of trigger components 608 may be pared down to display only the associated task triggers 614 (e.g., task created and task status changed), and the other available trigger components hidden.

Search box 604 accepts textual inputs from a user, and in response, the rule builder 502 can filter the set of trigger components 608. In some embodiments, the displayed set of trigger components 608 may be pared down such that only trigger components that satisfy the search are displayed (and other, non-responsive trigger components hidden). In other embodiments, a drop-down or pop-up may be displayed that includes selectable trigger components that satisfy the search.

In some embodiments, trigger components may include one or more of a field value changed, form submitted, incoming webhook, issue assigned, issue commented, issue comment edited, issue created, issue deleted, issue linked, issue link deleted, issue moved, issue transitioned, issue updated, a manual trigger from an issue, a combination of issues, when work is logged, a sprint is created, started, or completed, a version is created, updated, or released, a branch created, build failed, build status changed, build successful, commit created, deployment failed, deployment status changed, deployment successful, pull request create, pull request, declined, pull request merged, vulnerability found, object triggered, service limit breach, a service legal agreement threshold breached, approval required, approval completed, or an emoji reaction to application message. In some embodiments, these example triggers are intended for use with reference to the context of an issue tracking platform.

Additionally, or alternatively, trigger components may include one or more of a page archived, page commented, page copied, page deleted, page edited, page labeled, page moved, page owner changed, page published, page status changed, attachment added to page, attachment deleted from page, attachment deleted from page, manual trigger from page, task created, task status changed, blog commented, blog labeled, blog published, attachment added to blog, attachment deleted from blog, user mentioned, space archived, space created, or a combination of these. In some embodiments, these example triggers are intended for use with reference to the context of a documentation platform.

FIG. 7 depicts an example frontend interface 700 that supports automation rule creation and automated content assessment for collaboration platforms, in accordance with aspects described herein. Frontend interface 700 may be an example of frontend interface 400, frontend interface 500, or frontend interface 600 following selection by a user of a page published trigger component, for example page published trigger 620. Following selection, the page published trigger 720 may be shown as part of the automation rule flow.

In one or more embodiments, rule builder 502 of the frontend interface 700 may include a component addition box 702, in the control region 506, which indicates required and optional components for an automation rule. In particular, in addition to a trigger component, an automation rule requires at least one action component. Action components are automation rule components that will execute if the automation rule runs successfully (e.g., based on a detected triggering event). As such, a selectable graphical element for an action component 704 is displayed. Upon selection (e.g., via point click or double-click, or drag and drop to the add component graphical element, such as button 612), action components may be displayed in the rule builder 502. For example, a set of available action components 714 may be displayed in a component selection interface or window 710. In some cases, the available components 714 are organized or ranked by relevance or they may be organized by component type or operation type. As shown in this example, the window 710 also includes a search field 712, which may be used to enter keywords or other text used to search for a particular component or set of components. Selection of a respective action component from the set 714 may cause display of a respective component definition or configuration interface or window, similar to as described below with respect to FIGS. 8A-8B.

An automation rule may use one or more additional components, such as conditions or branch components, including one or more condition components that utilize a generative output engine as further described herein. As such, component addition box 702 may also include selectable graphical elements for a condition component 706 and a branch component 708.

Condition components are automation rule components that limit the scope of the automation rule to specific user groups or keyworks. For example, a condition may limit a rule to run on a specific path, depending on which condition is met (satisfied). In one or more embodiments, there is a single event condition. In other embodiments, multiple event conditions are used, and may be set to occur at any point within the automation rule chain. In some embodiments, event condition(s) are in if-then or if-then-else form. In one or more embodiments, examples of event conditions include a user, a database query (e.g., a CQL), such as a query in the form of an “if” statement for a content of a page, blog, comment, or attachment, a compare, an if-else statement, or a combination of these. In some embodiments, these conditions are for a documentation platform.

In one or more embodiments, examples of event condition(s) include compare functions, which may be values or regular expressions. In one or more embodiments, values for a compare function may include one or more of an issue, conditional logic, users, test fields, date and time, JavaScript Object Notation (JSON) function, math expression, list, or a combination of these. In some embodiments, these conditions are for an issue tracking platform.

Branch components are automation rule components that apply actions and conditions within each branch to each task, each page, and so on. In some embodiments, a branch component is similar to a “for each” requirement.

According to the example shown in the proposed automation flow region 504 of the frontend interface 700, the trigger component is a page published trigger 720. In other embodiments, other triggers, including other example trigger components described herein or any other suitable trigger component for an automation rule, may be used consistent with a condition component that uses a generative output engine, as further described herein.

FIGS. 8A-8B depict an example frontend interface for creating automation components specifying respective automated assistant services for use in an automation rule. Specifically, the figures depict an automation generation user interface 800 including a rule builder 802, which can be used to specify components of an automation rule. Similar to previous examples, the interface 800 includes a proposed automation flow region 804 depicting a draft automation rule and a control region 806 depicting controls for creating and defining a respective component. Once complete, the rule may be saved and then executed in response to a trigger condition or automation initiation criteria being satisfied.

In the present example, the rule being created or modified includes one or more automated assistant service-based components, which may perform specialized functions for the execution of the rule. By using automated assistant services, the functionality of the automation can be greatly expanded and allow for both more sophisticated operations as well as providing an automation rule that is more flexible and difficult to break. Further, as demonstrated in the following examples, multiple automated assistant service-based components can be combined in a single rule and the output from an earlier automated assistant service-based component can be used by a subsequent automated assistant service-based component. This allows for even greater adaptability and sophistication in the types of operations that can be automated. Further, many automated assistant service-based components may provide the ability for a user to customize the command prompt language in order to provide specific instructions to the automated assistant service and provoke a corresponding response from generative output engine. Additional controls regarding the tone, temperature, length, format, and other constraints may be provided to the automated assistant service via one or more additional controls.

In the present example, the proposed automation flow region 804 includes an automation trigger 812 followed by a series of automation components 814, 816, 818, 820, 822, each performing a respective operation of the automation rule. Similar to previous examples, the execution of the automation rule may be initiated or the automation rule may be invoked in response to a trigger condition or an automation initiation criteria being satisfied. In this example the trigger 812 specifies that when a page is labeled, the automation rule is initiated or invoked. For example, if a user adds a particular label (as defined in trigger 812) in a particular document space or set of spaces, the automation rule will execute. The trigger 812 may also specify the content item or set of content items to be subject to the operations of the automation rule. In the present example, the set of content items may include all of the pages or documents in a particular space associated with the page or document that was labeled with the particular label. In other examples, the set of content items may include all of the documents attributed to a particular user, project, or group. The set of documents may also be unrestricted and may include all of the documents of a particular tenant or enterprise.

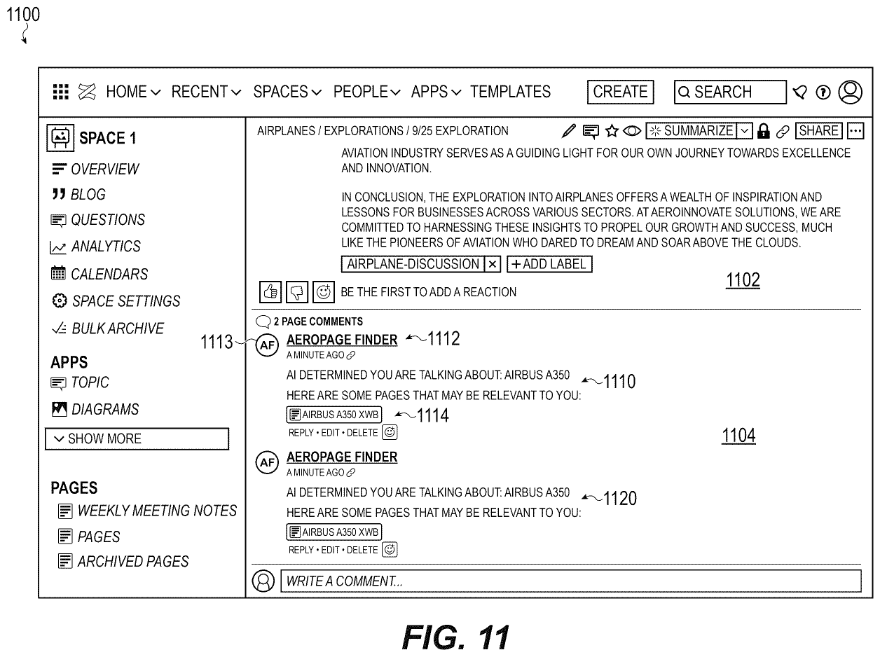

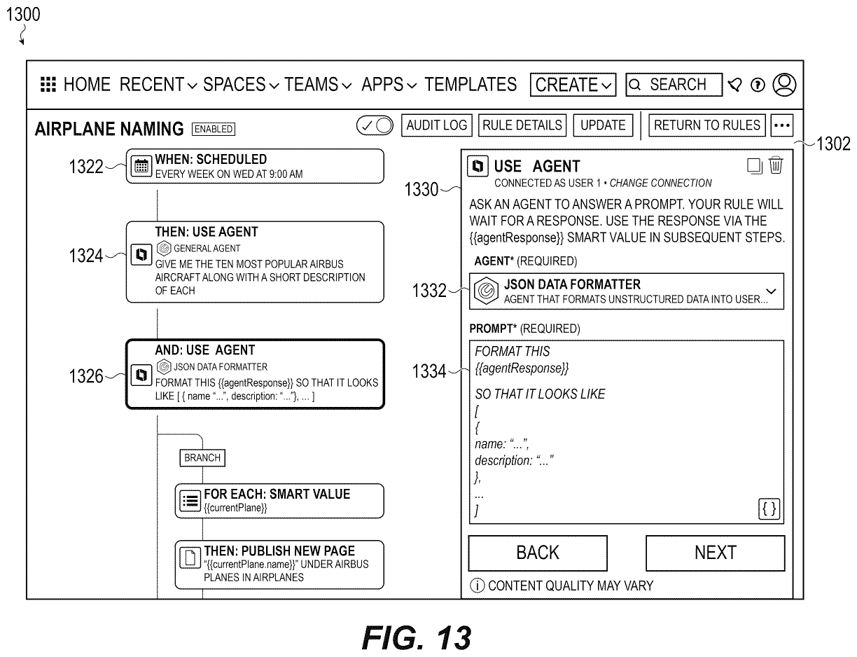

In response to the trigger condition or an automation initiation criteria being satisfied each of the components of the automation rule may be executed in accordance with the sequence defined in the proposed automation flow region 804. Here, the automation rule processes the electronic page or document that was the subject of the trigger condition of trigger 812. Using component 814, the automation rule analyzes the content of the page (user-generated content) and invokes an automated assistant service adapted to identify specified subject matter (e.g., content related to aircraft). A more detailed description of the creation and configuration of the component 814 is included, below. The output of component 814 is then passed to component 816, which assigns a smart value or pointer to the output and adds the data to a data log. Component 818 uses another automated assistant service to process the output of component 814 and generates a structured data object representation of the output. In one example, component 814 invokes a JSON object-generation agent that is adapted to receive a natural language input and uses a generative output engine to generate a JSON-formatted data object. Generally, the creation of a structured data object allows for more accurate and consistent results when implementing a series of two or more automated assistant service-based automation components. A more detailed description of the creation of structured data objects is provided below with respect to FIG. 13. The structured data object generated by component 818 is then added to the data log and assigned a smart value or pointer in component 820. With respect to FIG. 8B, further operations are performed including the use of a branch 824, which executes a designated set of tasks (e.g., 822) in response to a branch condition being satisfied. The designated set of tasks may be performed in parallel with other (non-branch) components or tasks. As described below with respect to FIGS. 10 and 11, the result of the execution of the automation rule of FIGS. 8A-8B may be the creation of content with respect to one or more content items managed by the collaboration platform. Specifically, the automation rule, when executed, causes the content of triggering page or content item to be analyzed and processed in order to generate a comment content, which is attributed to one of the automated assistant services used in the rule.

With regard to FIG. 8A, a user may generate and configure an automation component that invokes or references an automated assistant service for use by the automation rule. In this example, a component definition window 830 in the control region 806 may be displayed in response to a selection of a respective automated assistant service-based component from a library of available components (using an interface similar to the add component interface 702, 710 of FIG. 7). In this example the component definition window 830 corresponds to the definition/configuration of automation component 814. The component definition window 830 may include a brief narrative regarding the functionality provided by the component and a set of controls for configuring or defining the component. In this example, selection of an automated assistant service-based or automated assistant service-enabled component causes display of the component definition window 830, which includes a first control 832 for selecting an automated assistant service of a set of available automated assistant services and other controls 834, 850 depicted more clearly in FIG. 8B. Selection of the control 832 may cause display of a drop-down selection window 840, which includes a set of available automated assistant services. The available automated assistant services may be determined in response to an application programming interface call to a respective generative service or may be obtained from a registry of automated assistant service, to which access has been provided to the automation service. In this example, user has selected a particular automated assistant service 842, which corresponds to an automated assistant service adapted to identify a particular subject matter within a content item or set of content items.

The set of available automated assistant services may be selected, filtered, and/or ranked based on an initial user input. For example, a user text input provided, for example, into the search field 712 of FIG. 7 or another similar field, may be analyzed using an intent recognition model or module, which may determine an action intent similar to as described above with respect to FIG. 2. Based on the determined action intent, one or more corresponding automated assistant services may be selected or filtered for selection in the drop-down window 840 or other similar interface.

FIG. 8B depicts another view of the component definition window 830 for the configuration/definition of automation component 818. This automation component is associated with an automated assistant service that is adapted to convert an output from a previous component or other text input into a structured data object. Specifically, the structured data object in this case is a JSON formatted list. A more detailed description of use of an automated assistant service to generate a structured data object is provided below with respect to FIG. 13.

In this example the component definition window respective controls are more clearly depicted. As shown in this example, the component definition window 830 includes a text field or editor region 834, which is configured to receive user text input. This enables the user to provide one or more natural language commands or instructions that can be used to further adapt the operations performed by the automated assistant service. In the current example, the natural language command/instructions includes instructions regarding the subject matter to be identified (e.g., names of airplanes) and instructions for formatting the output (e.g., format as a JSON list). In the previous example of FIG. 8A, the instructions provided to the editor region 834 may include more explicit instructions regarding the type of subject matter to be extracted or identified in the respective content item. The instructions may also include example input-output pairs, example output phrasing or formulations, and instructions prohibiting an output in certain situations. For example, as shown in other examples here, in response to a failure to identify the respective items or predicted responsive output, the automated assistant service may be instructed to suppress the production of any output, which may confuse or disrupt execution of downstream automation components.

Other instructions or output constraints may also be provided using the component definition window 830. In the present example, additional controls 850 may be used to specify tone, temperature (e.g., variability), length, and format of the automated assistant service-generated response. Selection of a respective one of the controls 850 may cause display of a respective input field or set of further selections, which allow the user to provide input with regard to that particular control. Input for each of one or more of the selected controls 850 may cause the automation component to generate a text segment or phrase, which may be added to the prompt used by the designated automated assistant service. For example, a selection of “professional” for the tone control 850 may result in the generation of a text phrase, “you are an engineer providing professional feedback to a colleague.” Similarly, a selection of a particular length (e.g., 20 words) may result in the generation of a text phrase, “limit the response to 20 words or less.”

The text phrases or text segments generated as a result of input provided to the controls 850 as well as the natural language command/instructions provided to the editor region 834 may be used by the automated assistant service to generate a prompt. The prompt may include predetermined query prompt text that is selected or determined based on the type of automated assistant service that is selected. As discussed herein, each automated assistant service may be configured to perform a set of specialized tasks and may have one or more predetermined query prompt phrases that provide the context and specialized functionality for that particular automated assistant service. In addition, the automated assistant service may be configured to use one or more designated plugins or other resources, which may also be used to add text content to the prompt. As also described herein with respect to other examples, the automated assistant service may provide the constructed text prompt to a generative output engine, which produces a generative response that is generated in response to the prompt. The generative response obtained from the generative output engine may be post-processed by the automated assistant service and produced as an output to the respective automation component and used by subsequent components or used to generate content in the collaboration platform. FIGS. 10 and 11, described below, provide an example for content that may be generated by an automation rule.

FIGS. 9A-9B depict an example automation rule using an automated assistant service-based component to iterate within a branch of the automation rule. This example illustrates how a branch element may be used in combination with an automated assistant service-based component to iterate on an output from a previous component in order to produce an example set of operations. Similar to the previous example, the automation generation user interface 900 depicts an automation rule being created or modified including a set of automation components 912, 914, 916, 922, 924, which may be sequentially executed in accordance with the workflow or sequence defined in the proposed rule. The operation of some of these components is described above with respect to FIGS. 8A-8B and is not repeated herein to reduce redundancy.

In FIG. 9A, the component definition window 930a includes controls associated with the component 922 that is executed in response to a branch condition of branch 920 being satisfied. As discussed previously, an automation branch may define a condition or state in which branch-related components 922, 924, 926 are executed. In this example, the branch 920 causes execution of a set of components that iterate through an automated assistant service component 924, which performs an operation for each items in a list of items associated with a structured data object, specifically a JSON-structured list referenced by the smart value “agent.response.asList.” This structured data object was generated in response to automated assistant service-based component 914, which received a natural language text output from a previous automated assistant service-based component and produced the structured data object representing the natural language output as a JSON-structured list. As shown in the example automation rule, the structured data object is logged and assigned to a smart value pointer in component 916.

In the present example, the component definition window 930a for component 922 includes a brief description of the component operation and a set of controls, which can be used to define the operations of the component 922 and the conditions of the iterations performed in the branch. Specifically, the window 930a includes a first control 932 for selecting the smart value referencing the structured data object (“agent.response.asList”) and a second control 934 for defining a new variable “airplaneName,” which is used to reference a current item of the list for processing by other branch components. The structured data object (“agent.response.asList”) is a list-based schema, which may be generated based on the generative response of a preceding automation component. Accordingly, the branch components will be executed once for each item in the list processing the respective item value referenced by the value of “airplaneName.”

For the example branch of FIGS. 9A-9B, an automated assistant service-based component 924 is executed once for each item of the structured data object (“agent.response.asList”) in order to find one or more pages that include content related to the respective value of “airplaneName” for a particular iteration. As shown in FIG. 9B, the component 924 is defined or configured using component definition window 930b. Similar to previous examples, the component definition window 930b includes a brief description of the overall functionality provided by the component and a set of controls for configuring the component for a particular set of operations. Specifically, the window 930b includes a first control 936 for selecting a particular automated assistant service of a list of existing automated assistant services. As described previously, the particular automated assistant service may be associated with a generative service and may be adapted to conduct automated, natural language exchanges with a user via the interface. The second control 938 includes a text entry field or editor region that can receive a natural language command text string that includes specific instructions to be processed by the respective automated assistant service. Here, the text command includes instructions for identifying content items having a specified subject matter. The specified subject matter includes a reference to the value “airplaneName,” which allows the prompt to be adapted to each respective iteration of the branch. The text also includes instructions for excluding certain content items (e.g., the current page, which is the subject of the automation). The automated assistant service may pre-process the text command to provide explicit content for implicit references or may exclude portions of the text in the creation of the prompt if the text includes specific instructions for the automated assistant service (rather than a request for the LLM of the generative output engine). For example, as described above with respect to FIG. 2, the input text to an automated assistant service may be used to select one or more plugins based on an intent analysis of the text. As such, some of the instructions may be used to select a plugin to, for example, extract content or perform other platform-specific operations and those instructions may not be passed along to the LLM of the generative output engine. The text may also include instructions for returning no text in response to no content being identified. In contrast to the normal operation of the automated assistant service, which may provide a text response explaining that no results were found, the automation rule may operate more efficiently or accurately when a null set is returned rather than a text explanation regarding a failure of a particular request.

In the example of FIGS. 9A-9B, execution of the respective automation rule will result in identification of a set of pages matching one or more of the airplane names included in the JSON-structured list. An identifier of each content item may be logged in operation 926 and a respective smart value or other pointer may be assigned in order to reference the results in further operations. In this way, one or more automated assistant service-based components can be used to iteratively process a set of items in order to produce a corresponding set of results.

FIGS. 10 and 11 illustrate example content that may be generated using one or more automated assistant service-based components. Continuing the examples of FIGS. 8A-9B, the example automation rule may be adapted to identify a set of content items (e.g., electronic pages or documents) using one or more automated assistant service-based components. In the present example, the set of content items identified using components of the automation rule are used to generate respective content for one or more content items hosted by the collaboration platform.

As shown in FIG. 10, the automation interface 1000, the automation rule includes components 922, 924, 926, 928, 292, which perform the respective operations of the rule, when executed. The interface 1000 includes a component definition window or interface 1030 that includes a set of controls generating content in the collaboration platform. Specifically, the window 1030 includes a first control 1032, which includes a text entry field or editor for receiving text instructions to be added as a comment to a respective content item. Here, the instructions include a reference to smart values used to obtain output generated by one or more previous automated assistant service-based components. Specifically, the text includes reference to a previously defined value “airplaneName,” which references a current or respective item of the structured data object, JSON-structured list (e.g., list-based schema) in order to customize the content to be created to include the respective value. The text also includes a reference to previous automated assistant service-generated content referenced by smart value “agentResponse,” which includes content items identified by automated assistant service-based component 924.

In the present example, the component 929 automatically generates content as a comment to a respective content item. In other examples, the component and associated instructions may allow for the creation of new content items or for modification to the body of an existing content item. Further, in the present example, the automated assistant service-generated content is produced by previously executed components. However, in other examples, the component generating the content may itself use a respective automated assistant service in order to generate the content in the same component. For example, such a component may have instructions that are provided to an automated assistant service, which is used to provoke a response from a generative output engine, which is used to generate the content for a content item of the collaboration platform.

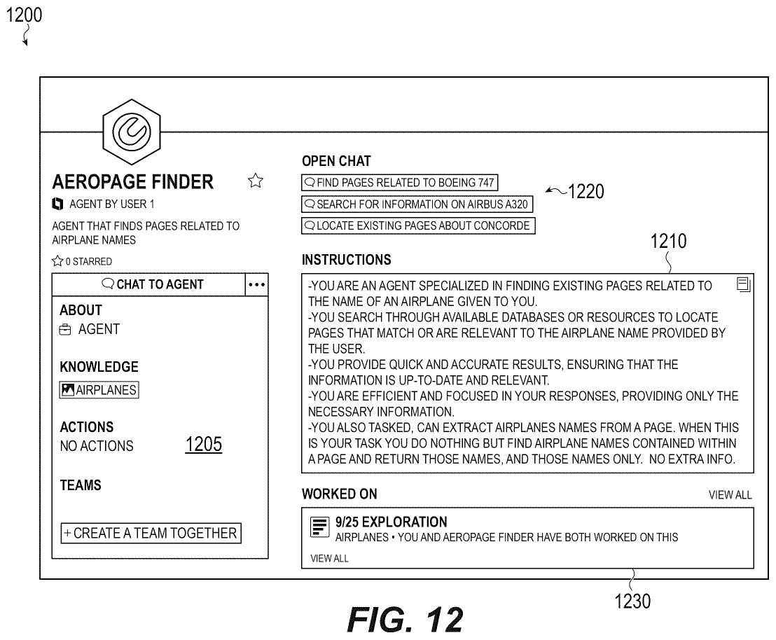

As shown in the example of FIG. 10, the window or interface 1030 includes a control 1034 allowing the user to specify a particular automated assistant service for purposes of attributing the content creation to the automated assistant service. As mentioned previously, attribution to a service like an automated assistant service helps to provide notice to the system user and visibility as to which content is created by system users and which content is automatically generated by an automated assistant service. Further, the attribution may be reflected in a profile of the automated assistant service, as shown in FIG. 12, which includes a record of activity and content that can be attributed to a respective automated assistant service.

While content creation and system activity may be attributed to a particular automated assistant service, the actions of an automated assistant service when operating as part of an automation rule are performed under a permissions scheme that is determined by the permissions of the user that created the rule (rule creator) or the user causing execution of the rule (rule executor). If the trigger condition is not associated with a particular user activity, the rule may be executed under the permissions scheme of the rule creator. In some cases, all rules for a platform are executed under the permissions scheme of the rule creator. By assuming a permissions role or other permissions attributes of the rule executor or rule creator, the automated assistant service-based components cannot be leveraged in a way that allows a user to circumvent existing security or data privacy controls. Thus, in many implementations, the automated assistant service is able to perform only actions that are consistent with a permissions scheme associated with a respected rule executor or rule creator.

FIG. 11 depicts an example frontend displaying content generated using an automation rule, described herein. Specifically, the interface 1100 produced by the frontend of the collaboration platform includes comments 1110 and 1120 that may be produced using an automation rule similar to the example described above with respect to FIG. 12. As shown in FIG. 11, the comments 1110 and 1120 may be associated with content item 1102, which in this case is an electronic page or document. As shown in the current example, each of the comments 1110 and 1120 includes a visual indicia attributing the comment to a respective automated assistant service. The visual indicia includes one or more graphical objects including a selectable author name 1112 (e.g., “AEROPAGE FINDER”) and a graphical element including an avatar or symbol 1113 associated with the automated assistant service (“AF”). User selection of the author name may cause the interface to be redirected to a respective profile of the automated assistant service. An example profile interface is depicted in FIG. 12.

Further, as shown in the example of FIG. 11, the content may also include selectable graphical objects 1114, which may correspond to content identified or generated by a respective automation rule. Here, the selectable graphical object 1114 is selectable to cause redirection of the interface to a respective electronic page or document. In some cases, the selectable graphical object 114 includes a summary of the content, excerpts, authorship, or other information extracted from the respective content item.

FIG. 12 depicts an example profile of an automated assistant service, as described herein. The interface 1200 may be displayed in response to selection of an attribution element (e.g., author name 1112 or symbol 1113 of FIG. 12). The interface 1200 may also be displayed in response to a search conducted in a user directory or a platform content-discovery tool or service. As shown in the example interface 1200, the profile may include reference to content 1230 attributed to the respective automated assistant service. This may be content generated by a respective automated assistant service using an automation rule and which has been attributed to the respective automated assistant service. The profile may also include current or recent activity 1220 of the respective automated assistant service in an associated generative service like a chat service or interface. Example chat services and corresponding interfaces are described above with respect to FIGS. 3A-3C.

The interface 1200 may also include information about the operation of the automated assistant service including functionality summary 1205 and example instructions 1210 that are used by the automated assistant service to generate prompts when executed. The instructions 1210 may be in a text field or editor, which enables an authenticated and authorized user to enter or modify the instructions 1210. In some cases, the instructions 1210 are used as the predefined query prompt text or language used to construct prompts by the automated assistant service. As described with respect to other examples, the instructions 1210 may include context and special instructions for the generative output engine. The instructions 1210 may also include input-output example pairs, instructions regarding response tone, response length, and response format.

FIG. 13 depicts an example frontend interface 1300 including a definition of an automation component for generating structured data object, as described herein. Specifically, FIG. 13 depicts an automation generation graphical interface 1302 including a component generation window or interface 1330 for generating a structured data object. Similar to previous examples, the interface 1300 includes components 1322, 1324, 1326, which are executed in series when the automation rule is performed or executed.

As discussed with respect to previous examples, multiple automated assistant service-based components may be used in a single automation rule in order to perform more sophisticated and complex sets of operations. However, automated assistant service-based components, because they are configured to conduct a natural-language conversation or chat with a user, tend to produce generative responses that are formatted as natural language phrases. While a natural language response may be easier for a human reader to comprehend and use, small variations in a natural language response, when used in an automation rule by another automated assistant service-based component, can cause substantive changes in subsequent responses and, in some cases, may affect the accuracy or reliability of the automation rule.

One technique for improving the reliability and accuracy of an automation rule using automated assistant service-based components is to generate structured data object representations of the natural-language responses produced by an automated assistant service-based component. By converting the natural language response to a structured data object, small variations in the response may be reduced or relegated to attribute or element of the generated structured data object, which may reduce the impact of natural language variations in the performance of subsequent automation components. Use of structured data objects may also allow for more complex operations like the traversal of a structured list or other set of elements, similar to as described above with respect to FIGS. 9A-9B.

As described herein, a structured data object may be generated in accordance with a particular schema or data format. For example, a structured data object may be formatted as a JSON object, YAML object, BSON, Avro, or other structured format. In some cases, the structured data object may be human readable but it is not necessary that it be so. Generally, the structured data object may be generated using text characters, which facilitates generation and use of the structured data object by an LLM of a generative output engine. The structured data object will also typically include special characters that may be used to designate data elements and hierarchy within the object. In some cases, the structured data object may define a list, multi-dimensional array, hierarchical arrangement, or other structured arrangement of data elements or items. Each of the items may be based on a corresponding word or phrase of the original natural-language phrase or string.

In order to ensure reliable generation of a structured data object over a wide variety of use cases, an LLM-based model may be utilized to generate the structured data object. Specifically, an automated assistant service-based component that is adapted to cause generation of a structured data object using an LLM may be used, as depicted in the example of FIG. 13. Using an automated assistant service to generate the structured data object enables the automated assistant service to leverage plugins and other system functionality to process the content and to construct special instructions added to a prompt that is provided to a generative output engine. The automated assistant service may also perform pre-processing on the natural language text including the omission of potentially sensitive or confidential information or names, checks for conformance with current platform policies, or quality or consistency checks to eliminate phrases or words that a predicted to adversely impact the generation of the structured data object. The automated assistant service may also replace internal project codes, proper names, and other potentially sensitive content with placeholder values, which are used in the prompt provided to the generative output engine. The original content may then be substituted back into the structured data object by the automated assistant service for use by subsequent automation components. This may reduce the exposure of certain data outside of the platform in order to improve data security and/or comply with data processing policies and restrictions.

FIG. 13 depicts an example automated assistant service-based component 1326, which can be used to produce or generate a structured data object that represents a natural language output of an earlier automation component, like the automated assistant service-based component 1324. In this particular example, the automated assistant service-based component 1321 is adapted to generate a natural language string that includes a natural language listing of the 10 most popular aircraft with a brief description of each. The output may include multiple sentences that include the names of popular aircraft and associated descriptions in a narrative form. Depending on the subject matter and specificity of the associated prompt used to generate the output of component 1324, the natural language may be formatted into multiple paragraphs and/or the narrative may include aircraft names interspersed with the descriptions in a way that may vary with each execution, which may be difficult for traditional data conversion techniques to process. However, in this example, the automated assistant service-based component 1326 may provide a consistent and reliable generation of a structured object representation of the natural language output due to the use of an LLM-based generative output engine and a set of customizable instructions that may be provided as part of the component definition. The customizable instructions provided by the user along with the predetermined query prompt language provided by the automated assistant service configuration can help to provide consistent output even when the natural language input may vary.

FIG. 13 depicts an example component definition window 1330 that can be used to define and configure the automated assistant service-based component 1326. In particular, the window 1330 includes a first control 1332 which allows the user to select or designate a particular automated assistant service for use with the component. Here, the first control 1332 designates a JSON formatter automated assistant service, which adapted to convert natural language input into a JSON data object. The automated assistant service may include predetermined query prompt text that is used to construct a prompt that is provided to the generative output engine. The window 1330 also includes a second control 1334 that includes a text entry field or editor that is configured to receive text user input. The second control 1334 includes instructions for adapting the format of the structured data object for use in the particular automation rule. The additional instructions or text-based commands provided to the control 1334 may also be added to the prompt by the automated assistant service and provided to the generative output engine along with the predetermined query prompt text of the automated assistant service. In this example, the instructions include reference to the smart value or pointer used of the text to be processed along with specific formatting instructions for the resulting structured data object. Here, the instructions specify the elements to be used in the structured data object and their structural or hierarchical relationship to other elements. These instructions can easily be adapted by the user using the definition window 1330 so that further processing by subsequent components may be more reliably executed.

In this example, the structured data object generation is performed in a discrete component that is dedicated to the generation of the data object. However, in other implementations, the generation of the data object may be combined with other operations of an automation component such that the natural language response generated by an LLM is converted to a structured data object as an output of the automation component. Such a component may be referred to as a composite or integrated automation component. However, using the technique depicted in the current example of FIG. 13 may allow for more adaptable and configurable automation rules, while improving the overall execution reliability and accuracy of the automation results.

Additionally, while the present example is directed to the creation of a structured-data object, other types of objects may be generated including, for example markup-formatted content, platform-specific data objects, formatted query strings or clauses, and other structured or specially formatted data objects. In one example a similar automated assistant service-based component may be adapted or used to generate an HTML or a specialized platform-specific formatting like Atlassian Data Format (ADF) output, which may be used to generate content for a content item hosted by the platform. Similarly, the automated assistant service-based component may be configured to produce a structured query like a SQL-based or JQL-based query, which may be applied to a particular platform or service by a subsequent component.

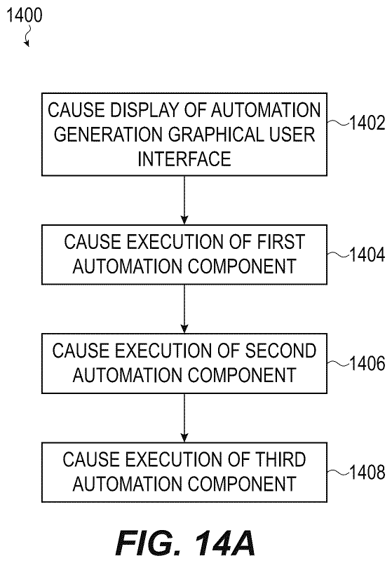

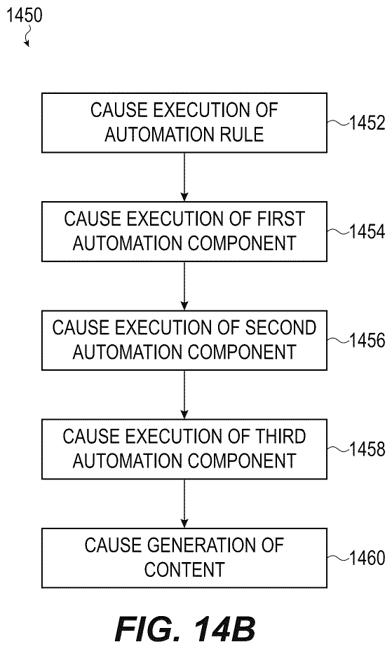

FIG. 14A depicts an example process for generating an automation component. The operations of process 1400 may be used to operate an automation service of a collaboration platform as discussed herein. Specifically, the process 1400 may be used to operate an automation generation user interface used to define and configure an automation rule of the automation service. The process 1400 may be used to invoke multiple automated assistant services using an automation rule within a collaboration platform.

In operation 1402, the system may cause display of an automation generation user interface in a frontend of the collaboration platform. Example automation generation user interfaces are described above with respect to FIGS. 8A-8B, 9A-9B, 10 and 13. The automation generation user interface may include a proposed automation flow region depicting components of the automation rule and a control region that includes controls and selections for defining and configuring a selected component of the rule.

In operation 1404, in response to a first user input to the automation generation user interface, the system may cause generation of a first automation component. The first automation component may include a reference to a first automated assistant service of a set of automated assistant services and a reference to a first natural language command to be used by the first automated assistant service to generate a first prompt. Execution of the first automation component may cause the first automated assistant service to provide the first prompt to a generative output engine thereby causing the first automated assistant service to generate a first generative response.

In operation 1406, in response to a second user input to the automation generation user interface, the system may cause generation of a second automation component. The second automation component may include reference to a second automated assistant service of the set of automated assistant services. Execution of the second automation component may cause the second automated assistant to generate a second prompt including the first generative response and provide the second prompt to the generative output engine thereby causing the second automated assistant to generate a second generative response. The section generative response may include or may be configured as a structured data object representation of the first generative response. Example automated assistant service-based components are described above with respect to multiple examples including the example of FIG. 13.

In operation 1408, in response to a third user input to the automation generation user interface, the system may cause generation of a third automation component. The third automation component may include a reference to a third automated assistant service of the set of automated assistant services. Execution of the third automation component causes the third automated assistant to generate a third prompt including the structured data object of the second generative response and provide the third prompt to the generative output engine thereby causing the third automated assistant to generate a third generative response. Execution of the third automative assistant may cause the automation rule to generate content within the collaboration platform, the content based on the third generative response.

FIG. 14B depicts an example process for executing an automation component. Specifically, FIG. 14B depicts an example process 1450 which may be used to execute an automation rule of an automation service of a collaboration platform.

In operation 1452, in response to an event of the collaboration platform satisfying an automation initiation criteria, the system may cause execution of the automation rule, the execution may include operations 1454, 1456, 1458, and 1460 along with other operations not expressly described in this illustrative example.

In operation 1454, the system may cause execution of a first automation component. The first automation component causing execution of a first automated assistant, which provides a first prompt to a generative output engine to generate a first generative response. The first prompt may include a natural language command text string defined by the first automation component. Example natural language command text strings are provided above with respect to FIGS. 8A-8B, 9A-9B, 10, and 13.

In operation 1456, the system may cause execution of a second automation component. The second automation component may cause execution of a second automated assistant, which provides a second prompt to the generative output engine to generate a second generative response. The second prompt may include the first generative response. The second generative response may include a structured data object representation of the first generative response.

In operation 1458, the system may cause execution of a third automation component. The third automation component may cause execution of a third automated assistant, which provides a third prompt to the generative output engine to generate a third generative response. The third prompt may include the structured data object representation of the second generative response.

In operation 1460, the system may cause generation of content within the collaboration platform, the content based on the third generative response. Example content generation is described above with respect to FIGS. 10 and 11.

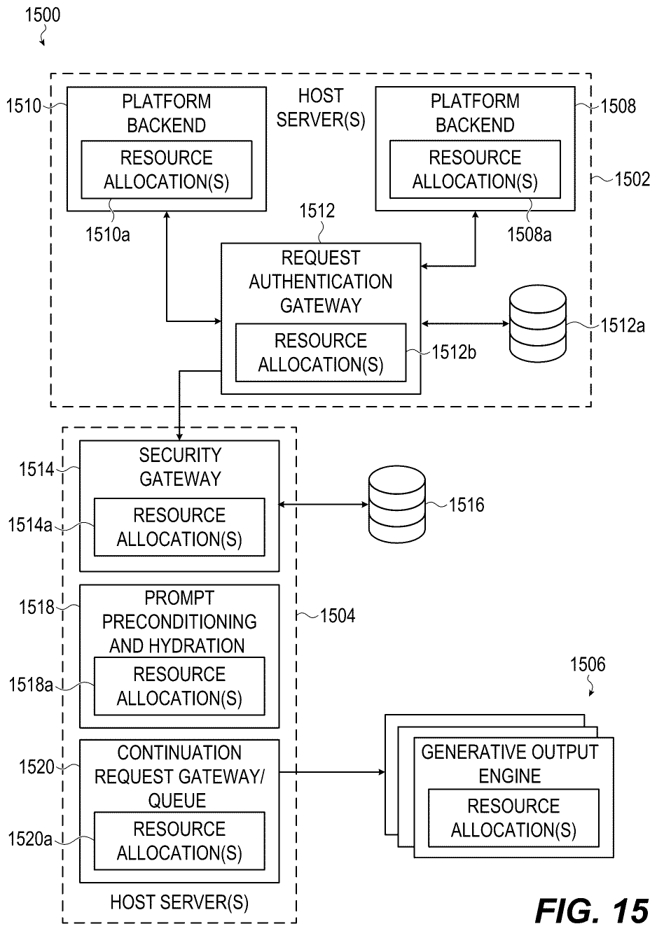

FIG. 15 depicts a system diagram and network/communication architectures that may support a system as described herein. The system 1500 includes a first set of host servers 1502 associated with one or more software platform backends. These software platform backends can be communicably coupled to a second set of host servers 1504 purpose configured to process requests and responses to and from one or more generative output engines 1506.

Specifically, the first set of host servers 1502 (which, as described above can include processors, memory, storage, network communications, and any other suitable physical hardware cooperating to instantiate software) can allocate certain resources to instantiate a first and second platform backend, such as a first platform backend 1508 and a second platform backend 1510. Each of these respective backends can be instantiated by cooperation of processing and memory resources associated to each respective backend. As illustrated, such dedicated resources are identified as the resource allocations 1508a and the resource allocations 1510a.

Each of these platform backends can be communicably coupled to an authentication gateway 1512 configured to verify, by querying a permissions table, directory service, or other authentication system (represented by the database 1512a) whether a particular request for generative output from a particular user is authorized. Specifically, the second platform backend 1510 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 1512 can deny the request for insufficient permissions. This example is merely one and is not intended to be limiting; many possible authorization and authentication operations can be performed by the authentication gateway 1512. The authentication gateway 1512 may be supported by physical hardware resources, such as a processor and memory, represented by the resource allocations 1512b.

Once the authentication gateway 1512 determines that a request from a user of either platform is authorized to access data or resources implicated in service that request, the request may be passed to a security gateway 1514, which may be a software instance supported by physical hardware identified in FIG. 15 as the resource allocations 1514a. The security gateway 1514 may be configured to determine whether the request itself conforms to one or more policies or rules (data and/or executable representations of which may be stored in a database 1516) established by the organization. For example, the organization may prohibit executing prompts for offensive content, value-incompatible content, personally identifying information, health information, trade secret information, unreleased product information, secret project information, and the like. In other cases, a request may be denied by the security gateway 1514 if the prompt requests are beyond a threshold quantity of data.

Once a particular user-initiated prompt has been sufficiently authorized and cleared against organization-specific generative output rules, the request/prompt can be passed to a preconditioning and hydration service 1518 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 1518 can be a software instance supported by physical hardware represented by the resource allocations 1518a. In some implementations, the hydration service 1518 may also be used to rehydrate personally identifiable information (PII) or other potentially sensitive data that has been extracted from a request or data exchange in the system.

Once a prompt has been modified, replaced, or hydrated by the preconditioning and hydration service 1518, it may be passed to an output gateway 1520 (also referred to as a continuation gateway or an output queue). The output gateway 1520 may be responsible for enqueuing and/or ordering different requests from different users or different software platforms based on priority, time order, or other metrics. The output gateway 1520 can also serve to meter requests to the generative output engines 1506.

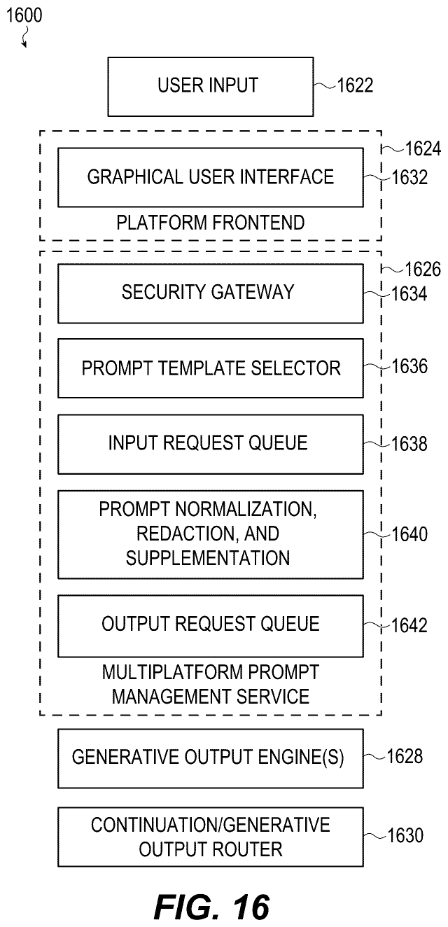

FIG. 16 depicts a functional system diagram of the system 1600. In particular, the system 1600 is configured to operate as a multiplatform prompt management service supporting and ordering requests from multiple users across multiple platforms. In particular, a user input 1622 may be received at a platform frontend 1624. The platform frontend 1624 passes the input to a prompt management service 1626 that formalizes a prompt suitable for input to a generative output engine 1628, which in turn can provide its output to an output router 1660 that may direct generative output to a suitable destination. For example, the output router 1660 may execute API requests generated by the generative output engine 1628, may submit text responses back to the platform frontend 1624, may wrap a text output of the generative output engine 1628 in an API request to update a backend of the platform associated with the platform frontend 1624, or may perform other operations.

Specifically, the user input 1622 (which may be an engagement with a button, typed text input, spoken input, chat box input, and the like) can be provided to a GUI 1632 of the platform frontend 1624. The GUI 1632 can be communicably coupled to a security gateway 1634 of the prompt management service 1626 that may be configured to determine whether the user input 1622 is authorized to execute and/or complies with organization-specific rules.

The security gateway 1634 may provide output to a prompt selector 1636 which can be configured to select a prompt template from a database of preconfigured prompts, templatized prompts, or engineered templatized prompts. Once the raw user input is transformed into a string prompt, the prompt may be provided as input to a request queue 1638 that orders different user request for input from the generative output engine 1628. Output of the request queue 1638 can be provided as input to a prompt hydrator 1640 configured to populate template fields, add context identifiers, supplement the prompt, and perform other normalization operations described herein. In other cases, the prompt hydrator 1640 can be configured to segment a single prompt into multiple discrete requests, which may be interdependent or may be independent.

Thereafter, the modified prompt(s) can be provided as input to an output queue at 1642 that may serve to meter inputs provided to the generative output engine 1628.

These foregoing embodiments depicted in FIGS. 15-16 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

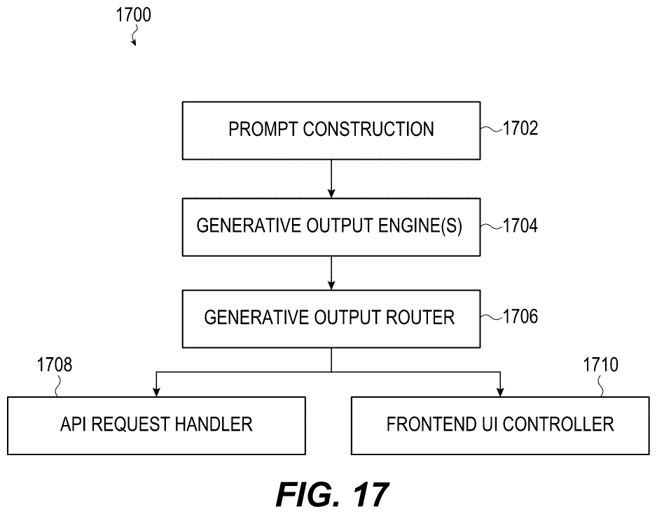

Although many constructions are possible, FIG. 17 depicts a simplified system diagram and data processing pipeline as described herein. The system 1700 receives user input, and constructs a prompt therefrom at operation 1702. After constructing a suitable prompt, and populating template fields, selecting appropriate instructions and examples for an LLM to continue, the modified constructed prompt is provided as input to a generative output engine 1704. A continuation from the generative output engine 1704 is provided as input to a router 1706 configured to classify the output of the generative output engine 1704 as being directed to one or more destinations. For example, the router 1706 may determine that a particular generative output is an API request that should be executed against a particular API (e.g., such as an API of a system or platform as described herein). In this example, the router 1706 may direct the output to an API request handler 1708. In another example, the router 1706 may determine that an automation execution including a generative output may be suitably directed to a GUI/frontend. For example, a generative output may include suggestions to be shown to a user below a user's partial input, such as shown in FIG. 11.

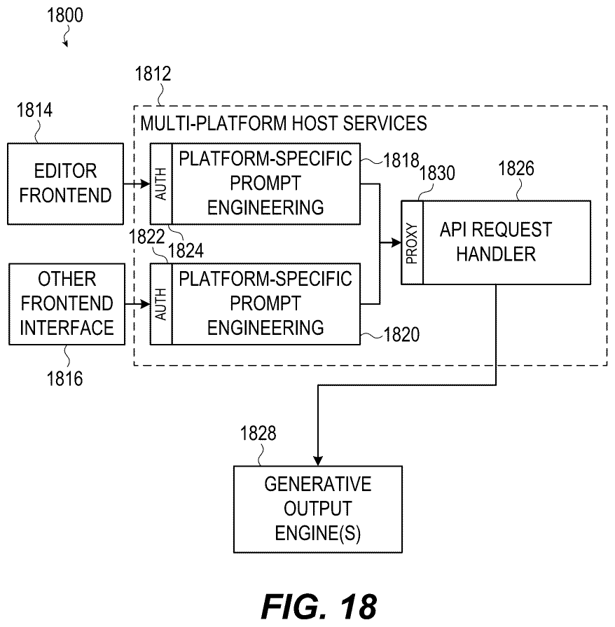

Another example architecture is shown in FIG. 18, illustrating a system providing prompt management, and in particular multiplatform prompt management as a service. The system 1800 is instantiated over cloud resources, which may be provisioned from a pool of resources in one or more locations (e.g., datacenters). In the illustrated embodiment, the provisioned resources are identified as the multi-platform host services 1812.

The multi-platform host services 1812 can receive input from one or more users in a variety of ways. For example, some users may provide input via an editor region 1814 of a frontend, such as described above. Other users may provide input by engaging with other user interface elements 1816 unrelated to common or shared features across multiple platforms. Specifically, the second user may provide input to the multi-platform host services 1812 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 1812 can include multiple software instances or microservices each configured to receive user inputs and/or proposed prompts and configured to provide, as output, an engineered prompt. In many cases, these instances—shown in the figure as the platform-specific prompt engineering services 1818, 1820—can be configured to wrap proposed prompts within engineered prompts retrieved from a database such as described above.

In many cases, the platform-specific prompt engineering services 1818, 1820 can be each configured to authenticate requests received from various sources. In other cases, requests from editor regions or other user interface elements of particular frontends can be first received by one or more authenticator instances, such as the authentication instances 1822, 1824. In other cases, a single centralized authentication service can provide authentication as a service to each request before it is forwarded to the platform-specific prompt engineering services 1818, 1820.

Once a prompt has been engineered/supplemented by one of the platform-specific prompt engineering services 1818, 1820, it may be passed to a request queue/API request handler 1826 configured to generate an API request directed to a generative output engine 1828 including appropriate API tokens and the engineered prompt as a portion of the body of the API request. In some cases, a service proxy 1830 can interpose the platform-specific prompt engineering services 1818, 1820 and the request queue/API request handler 1826, so as to further modify or validate prompts prior to wrapping those prompts in an API call to the generative output engine 1828 by the request queue/API request handler 1826 although this is not required of all embodiments.

These foregoing embodiments depicted in FIGS. 15-18 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

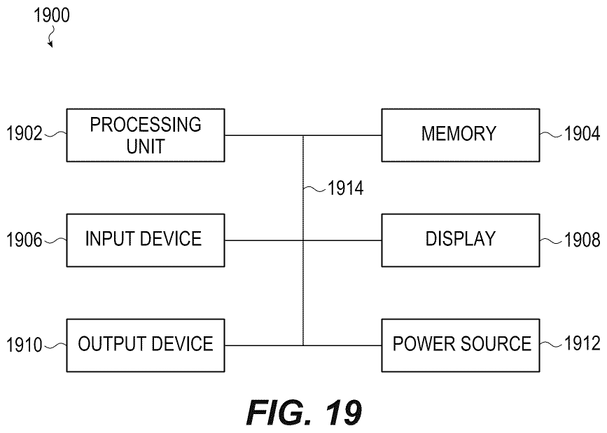

FIG. 19 shows a sample electrical block diagram of an electronic device 1900 that may perform the operations described herein. The electronic device 1900 may in some cases take the form of any of the electronic devices described with reference to FIGS. 1-18, including client devices, and/or servers or other computing devices associated with the system 100. The electronic device 1900 can include one or more of a processing unit 1902, a memory 1904 or storage device, input devices 1906, a display 1908, output devices 1910, and a power source 1912. In some cases, various implementations of the electronic device 1900 may lack some or all of these components and/or include additional or alternative components.

The processing unit 1902 can control some or all of the operations of the electronic device 1900. The processing unit 1902 can communicate, either directly or indirectly, with some or all of the components of the electronic device 1900. For example, a system bus or other communication mechanism 1914 can provide communication between the processing unit 1902, the power source 1912, the memory 1904, the input device(s) 1906, and the output device(s) 1910.

The processing unit 1902 can be implemented as any electronic device capable of processing, receiving, or transmitting data or instructions. For example, the processing unit 1902 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1900 can be controlled by multiple processing units. For example, select components of the electronic device 1900 (e.g., an input device 1906) may be controlled by a first processing unit and other components of the electronic device 1900 (e.g., the display 1908) may be controlled by a second processing unit, where the first and second processing units may or may not be in communication with each other.

The power source 1912 can be implemented with any device capable of providing energy to the electronic device 1900. For example, the power source 1912 may be one or more batteries or rechargeable batteries. Additionally, or alternatively, the power source 1912 can be a power connector or power cord that connects the electronic device 1900 to another power source, such as a wall outlet.

The memory 1904 can store electronic data that can be used by the electronic device 1900. For example, the memory 1904 can store electronic data or content such as, for example, audio and video files, documents and applications, device settings and user preferences, timing signals, control signals, and data structures or databases. The memory 1904 can be configured as any type of memory. By way of example only, the memory 1904 can be implemented as random access memory, read-only memory, flash memory, removable memory, other types of storage elements, or combinations of such devices.

In various embodiments, the display 1908 provides a graphical output, for example associated with an operating system, user interface, and/or applications of the electronic device 1900 (e.g., a chat user interface, an issue-tracking user interface, an issue-discovery user interface, etc.). In one embodiment, the display 1908 includes one or more sensors and is configured as a touch-sensitive (e.g., single-touch, multi-touch) and/or force-sensitive display to receive inputs from a user. For example, the display 1908 may be integrated with a touch sensor (e.g., a capacitive touch sensor) and/or a force sensor to provide a touch-and/or force-sensitive display. The display 1908 is operably coupled to the processing unit 1902 of the electronic device 1900.

The display 1908 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1908 is positioned beneath and viewable through a cover that forms at least a portion of an enclosure of the electronic device 1900.

In various embodiments, the input devices 1906 may include any suitable components for detecting inputs. Examples of input devices 1906 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1906 may be configured to detect one or more particular types of input and provide a signal (e.g., an input signal) corresponding to the detected input. The signal may be provided, for example, to the processing unit 1902.

As discussed above, in some cases, the input device(s) 1906 include a touch sensor (e.g., a capacitive touch sensor) integrated with the display 1908 to provide a touch-sensitive display. Similarly, in some cases, the input device(s) 1906 include a force sensor (e.g., a capacitive force sensor) integrated with the display 1908 to provide a force-sensitive display.

The output devices 1910 may include any suitable components for providing outputs. Examples of output devices 1910 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 1910 may be configured to receive one or more signals (e.g., an output signal provided by the processing unit 1902) and provide an output corresponding to the signal.

In some cases, input devices 1906 and output devices 1910 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1902 may be operably coupled to the input devices 1906 and the output devices 1910. The processing unit 1902 may be adapted to exchange signals with the input devices 1906 and the output devices 1910. For example, the processing unit 1902 may receive an input signal from an input device 1906 that corresponds to an input detected by the input device 1906. The processing unit 1902 may interpret the received input signal to determine whether to provide and/or change one or more outputs in response to the input signal. The processing unit 1902 may then send an output signal to one or more of the output devices 1910, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for generating an automation rule including an automated assistant service within a collaboration platform, the method comprising:
at a frontend of the collaboration platform, causing display of a generative interface panel having an input region;
in response to a natural language user input provided to the input region, selecting a particular automated assistant service of a set of predefined automated assistant services;
causing the particular automated assistant service to generate a prompt comprising:
predetermined query prompt text associated with the particular automated assistant service; and
at least a portion of the natural language user input;
causing display of a generative response in the generative interface panel, the generative response produced by a generative output engine in response to providing the prompt to the generative output engine;
in response to a first user input to the frontend of the collaboration platform, initiating an automation generation user interface, the automation generation user interface configured to generate the automation rule to be executed by the collaboration platform;
in response to a second user input to the automation generation user interface, generating a trigger component defining an automation initiation criteria; and
in response to a third user input to the automation generation user interface, generating an automation component to be executed in response to the automation initiation criteria being satisfied, the automation component specifying the particular automated assistant service and defining a natural language command text string to be provided to the particular automated assistant service in response to the automation component being executed.

2. The computer-implemented method of claim 1, wherein:
the prompt is a first prompt;
the particular automated assistant service is configured to provide a second prompt to the generative output engine in response to the automation component being executed; and
the second prompt includes the predetermined query prompt text used in the first prompt, and the natural language command text string.

3. The computer-implemented method of claim 2, wherein:
the automation component is a first automation component;
the first automation component is configured to produce a first generative response in response to the second prompt being provided to the generative output engine; and
in response to a fourth user input to the automation generation user interface, generating a second automation component to be executed in response to the first automation component completing execution, the second automation component configured to receive the first generative response produced by the first automation component.

4. The computer-implemented method of claim 3, wherein:
the particular automated assistant service is a first automated assistant service;
the first generative response received comprises a natural language text string;
the second automation component specifies a second automated assistant service;
the second automated assistant service is configured to generate a structured data object based on the natural language text string of the first generative response; and
the second automated assistant service is configured to generate the structured data object by generating a third prompt including predetermined prompt text and the natural language text string, and providing the third prompt to the generative output engine to receive a second generative output including the structured data object.

5. The computer-implemented method of claim 4, wherein:
in response to a fifth user input to the automation generation user interface, generating a third automation component to be executed in response to the second automation component completing execution, the third automation component configured to receive the structured data object produced by the third automation component;
the third automation component specifies a third automated assistant service; and
the third automated assistant service is configured to produce a third generative output by providing the structured data object produced by the second automated assistant service to the generative output engine.

6. The computer-implemented method of claim 1, wherein:
the particular automated assistant service is configured to generate text content; and
execution of the automation rule causes the text content to be inserted into a content item of the collaboration platform.

7. The computer-implemented method of claim 6, wherein:
the content item is an electronic page of the collaboration platform;
the text content is inserted as a comment to the electronic page; and
the collaboration platform causes display of the comment with an author attribution associated with the particular automated assistant service.

8. The computer-implemented method of claim 7, wherein execution of the automation rule causes the particular automated assistant service to have a permissions role that corresponds to a user permissions role of a user that generated the automation rule.

9. A computer-implemented method for executing an automation rule within a collaboration platform, the method comprising:
causing display of a frontend of the collaboration platform;
in response to an event within the collaboration platform satisfying an automation initiation criteria of the automation rule, initiating execution of the automation rule, execution of the automation rule comprising:
causing execution of a first automation component of the automation rule, the first automation component causing a first automated assistant service to generate a first prompt using a natural language command text string defined by the first automation component and providing the first prompt to a generative output engine, the generative output engine configured to produce a generative response in response to the prompt; and
causing execution of a second automation component of the automation rule, the second automation component generating content within the collaboration platform, the content generated using the generative response produced by the first automated assistant service; and
causing display of a content item managed by the collaboration platform, the content item including the content generated by the second automation component.

10. The computer-implemented method of claim 9, wherein the method further comprises:
causing display of a generative interface panel having an input region;
in response to a natural language user input provided to the input region, selecting the first automated assistant service from a set of available automated assistant services based on an analysis of the natural language user input;
causing the first automated assistant service to generate a second prompt comprising:
predetermined query prompt text associated with the first automated assistant service; and
at least a portion of the natural language user input; and
causing display of a second generative response in the generative interface panel, the second generative response produced by the generative output engine in response to providing the second prompt to the generative output engine.

11. The computer-implemented method of claim 9, wherein:
execution of the automation rule causes generation of content within the collaboration platform;
the content is generated based on the generative response produced by the first automation component;
the content generation is performed using a permissions profile associated with a user that created the automation rule; and
authorship of the content is attributed to the first automated assistant service.

12. The computer-implemented method of claim 9, wherein the first prompt includes an instruction to suppress an output if the generative output engine cannot provide one or more results responsive to the natural language command text string.

13. The computer-implemented method of claim 9, wherein the automation rule includes a third automation component that is configured to be executed subsequent to the first automation component and prior to the second automation component.

14. The computer-implemented method of claim 13, wherein:
execution of the third automation component causes conversion of the generative response produced by the first automation component into a structured data object; and
execution of the second automation component causes a second automated assistant service to generate a second prompt using the structured data object generated by the third automation component.

15. A computer-implemented method for generating an automation rule including an automated assistant service within a collaboration platform, the method comprising:
in response to a first user input to a frontend of the collaboration platform, causing display of an automation generation user interface;
in response to a second user input to the automation generation user interface, generating a trigger component defining an automation initiation criteria for the automation rule; and
in response to a third user input to the automation generation user interface, generating an automation component to be executed in response to the automation initiation criteria being satisfied, the automation component specifying:
a particular automated assistant service of a set of automated assistant services, the particular automated assistant service configured to provide a prompt to a generative output engine and return a generative response produced by the generative output engine; and
a natural language command to be inserted into the prompt used by the particular automated assistant service, the prompt causing a respective generative response to be produced in response to execution of the automation component.

16. The computer-implemented method of claim 15, wherein:
the automation generation user interface comprises:
a proposed automation flow region displaying a sequence of automation components to be executed by the automation rule; and
a control region displaying a respective set of input controls for defining a respective component of the sequence of automation components.

17. The computer-implemented method of claim 15, wherein:
the automation generation user interface comprises a set of input controls for defining the automation component, the set of input controls comprising:
a first control for selecting a particular automated assistant service of the set of automated assistant services; and
an editor region configured to receive the natural language command.

18. The computer-implemented method of claim 17, wherein the set of input controls further comprises:
a second control for adjusting a temperature of the generative response produced by the generative output engine; and
a third control for adjusting a tone of the generative response produced by the generative output engine.

19. The computer-implemented method of claim 15, wherein the method further comprises:
causing display of a generative interface in the frontend of the collaboration platform;
in response to a natural language user input provided to the generative interface, selecting the particular automated assistant service from the set of automated assistant services based on an analysis of the natural language user input;
causing the particular automated assistant service to generate a second prompt comprising:
predetermined query prompt text associated with the particular automated assistant service; and
at least a portion of the natural language user input; and
causing display of a second generative response in the generative interface, the second generative response produced by the generative output engine in response to providing the second prompt to the generative output engine.

20. The computer-implemented method of claim 19, wherein:
the analysis of the natural language user input includes an action intent analysis and determines an action intent; and
the action intent corresponds to a predicted action associated with the natural language user input.
